(19) United States
(12) Patent Application Publication
(10) Pub. No.: US 2008/0103916 A1
(43) Pub. Date: May 1, 2008

(54) Apparatuses, methods, and systems for capital management product enrollment

(76) Inventors: Jon Carlo Camarador, Westampton, NJ (US); Michele Margarita Hunter, Bound Brook, NJ (US); Michele Andrea Bongiovanni, Hillsborough, NJ (US)

Correspondence Address: BAKER BOTTS L.L.P., 2001 ROSS AVENUE, SUITE 600, DALLAS, TX, 75201-2980, US

(21) Appl. No.: 11/590,975

(22) Filed: Oct. 31, 2006

(51) Int. Cl. G06Q 30/00

(52) U.S. Cl. 705/26

(57) ABSTRACT

An apparatus, method, and system for facilitating the enrollment of a party into a capital management product is disclosed. This system provides a centralized control structure for managing the enrollment of a party into a capital management product, such as a lockbox, and may communicate with multiple parties associated with the enrollment. It may receive, store and process data concerning the circumstances of a party applying for a capital management product. A logic construct may be used when processing the data to recommend a capital management product for the customer, which may include one of a number of previously-defined products or a custom-designed product. The system may then generate a proposal for customer to review based on the capital management product recommended and, if accepted, may facilitate the enrollment and activation of the accepting party into the recommended capital management product.

### FIELD

The present system is directed generally to apparatuses, methods, and systems for generating and enrolling parties into suitable capital management products, and more particularly, for providing a centralized system for generating and enrolling parties into suitable capital management products, and more particularly, to apparatuses, methods, and systems for automatically generating and enrolling parties in a suitable capital management product, and even more particularly, to apparatuses, methods, and systems for generating and enrolling parties in suitable lockbox services products.

### BACKGROUND

Previously, the selection of a suitable capital management product for a customer and the enrollment of that customer in a capital management product entailed a number of separate manual steps, many requiring inputs and actions by a variety of parties associated with the process. There was no central processing or maintenance of this enrollment process. Typically, someone wishing to enroll a customer in a capital management product would need to select or construct a capital management product to fit the needs and situation of the customer. This might entail speaking with third parties that could have an interest in the operation of the capital management product once the customer is enrolled and the product is set in place. This might also entail working with other concerned parties and the customer to select the most suitable capital management product. Once a suitable product has been selected and agreed upon by all parties involved, the customer must accept and submit the necessary information for the generation of the capital management product. This information is then used to generate the actual capital management product for the customer and may be put into practice. This is just one example of the variety of ways in which a customer may be enrolled in a capital management product. Although there is not one established method of doing so, current methods suffer from similar inefficiencies and lack a central processing or structure, or the ability to generate and/or maintain a capital management product through one central point. For these reasons and others, existing enrollment methods are lacking in both structure and efficiency, allowing for errors and requiring substantial effort and time in generating and enrolling the customer in a suitable capital management product.

### SUMMARY

Against this backdrop, the present system undertakes the task of developing a system for the selection and/or generation of a suitable capital management product, receiving inputs from various interested parties, and enrolling a customer into the capital management product. In one embodiment, an apparatus, method, and system is taught for the selection of an appropriate capital management product, the ability to generate a client proposal and a partner bank application, the preparation of the product, and the enrollment of the client in the product. In one embodiment, this apparatus, method, and system may be used to enroll a customer in a suitable lockbox service. The apparatus, method, and system comprises receiving data comprising one or more factors associated with a capital management product or party to be enrolled in a capital management product, processing said data, employing computer logic to determine whether to recommend a capital management product comprising one or more of a previously-defined capital management product or a custom-designed capital management product, and generating a proposal with pricing for the recommended capital management product.

It is an object of the present system to provide an improved process to enroll a customer in a suitable capital management product. It is a further object of the present system to provide a more efficient system for the selection, preparation, and enrollment of a customer in a suitable capital management product. It is a further object of the present system to provide a central control for processing all associated transactions and communications to the enrollment of a customer in a capital management product. It is a further object of the present system to automatically manage one or more steps of the process without manual control. It is a further object of the present system for such a capital management product to be a lockbox service.

### BRIEF DESCRIPTION OF THE DRAWINGS

In accordance with the present disclosure, the accompanying drawings illustrate certain non-limiting embodiments of the disclosure.

FIG. 1 illustrates one example embodiment incorporated into a Capital Management Product Enrollment System controller;

FIG. 2 illustrates one example of a prior art enrollment system;

FIG. 3 illustrates one example embodiment of a centralized enrollment system according to a Capital Management Product Enrollment System;

FIG. 4 illustrates representative stages through which the operation of one example embodiment of a Capital Management Product Enrollment System may be viewed;

FIG. 5 illustrates one example of a logic construct incorporated into a Capital Management Product Enrollment System;

FIGS. 6A-G are logic flow diagrams illustrating embodiments of a Capital Management Product Enrollment System.

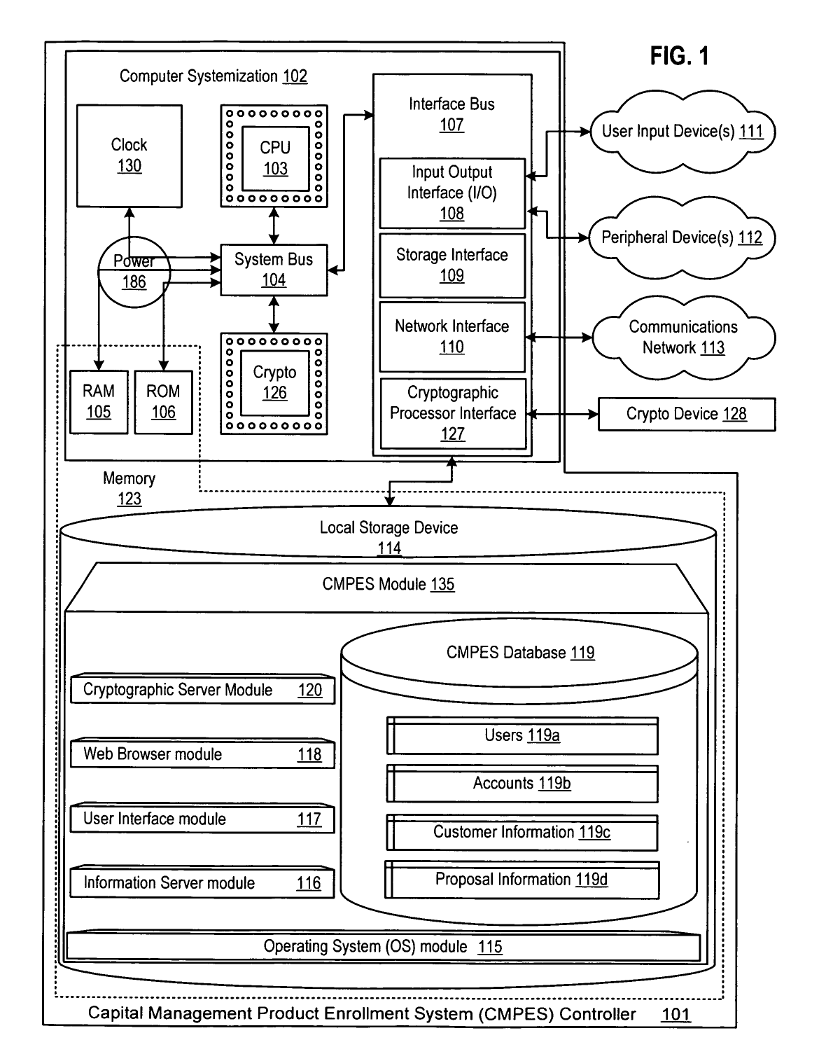

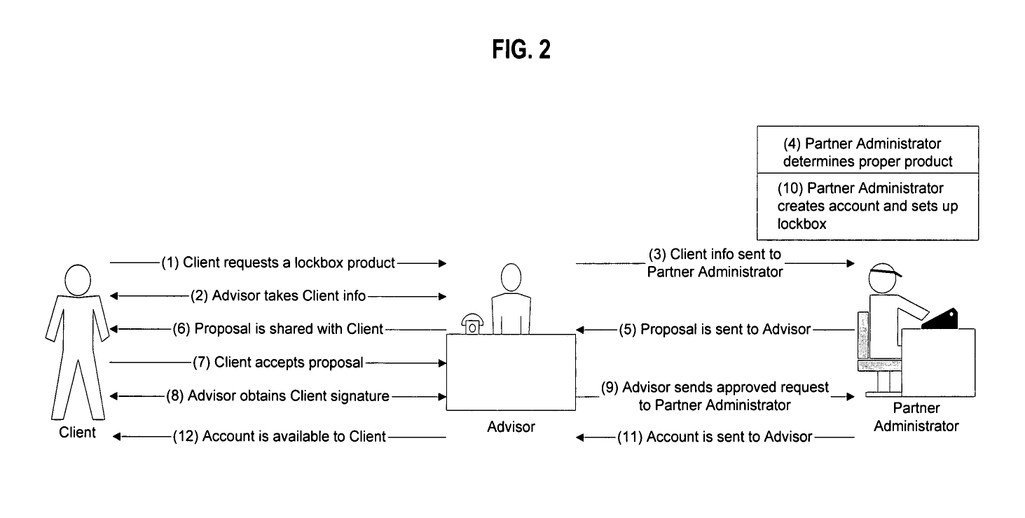

For ease of reference, the leading number of each reference number within the drawings indicates the first figure in which that reference number is introduced. As such, reference number 101 is first introduced in FIG. 1. Reference number 201 is first introduced in FIG. 2, etc.

### DETAILED DESCRIPTION

This disclosure provides a detailed explanation of the methodology used to select, prepare, and enroll a customer in a capital management product. It includes example apparatuses, methods, and systems for selecting, preparing, and enrolling a customer in a lockbox service product. It should be understood that the use of a lockbox service in this description is to be representative. This apparatus, method, and system may be used to select, prepare, and enroll a customer in a variety of capital management products and may be incorporated within a variety of embodiments within the teaching of this invention. The disclosed embodiments are representative only and are not exhaustive or exclusive. They are presented to assist in understanding the system. Further benefits and embodiments will become clear upon a reading of this disclosure. It should be understood that they are not representative of all systems defined by the claims, to be considered limitations on the system as defined by the claims, or limitations on equivalents to the claims. For instance, some of these embodiments may be mutually contradictory, in that they cannot be simultaneously present in a single embodiment. Thus, this summary of features and advantages are of a representative sample and should not be considered exhaustive, exclusive, and/or dispositive in determining equivalence. Additional features and advantages of the system will become apparent in the following description, from the drawings, and from the claims. As such, certain aspects of the disclosure have not been discussed herein. That alternate embodiments may not have been presented for a specific portion of the system or that further undescribed alternate embodiments may be available for a portion is not to be considered a disclaimer of those alternate embodiments. It will be appreciated that many of those undescribed embodiments incorporate the same principles of the system described and are equivalent. Thus, it is to be understood that other embodiments may be utilized and functional, logical, organizational, sequence, structural, temporal, and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of space and reducing repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure.

In describing embodiments of the system, in some cases specific terminology has been used for the sake of clarity. However, the system is not intended to be limited to and/or by the specific terms so selected, and it is to be understood that each specific term includes all technical equivalents which operate in a similar manner to accomplish a similar purpose. It should be noted that terms and or phraseology in this disclosure are not exhaustive in detail, and are not provided as definitive definitions. Rather, the terms are provided herein simply as an aid to the reader. The terms are not limiting of the disclosure and/or claims herein. The use of the terms may contemplate any of the broader, and/or multiple meanings found in common use, dictionaries, technical dictionaries, and/or in actual use in the technical arts, as well as any broadening made throughout this disclosure.

Some of these features may be mutually contradictory, in that they cannot be simultaneously present in a single embodiment. Similarly, some features are applicable to one aspect of the system, and inapplicable to others. In addition, the disclosure includes other systems not presently claimed. Applicant reserves all rights in those presently unclaimed systems including the right to claim such systems, file additional applications, continuations, continuations in part, divisions, and/or the like. It should be understood that aspects of the disclosure such as advantages, embodiments, examples, features, functional, logical, organizational, sequence, structural, temporal, topological, and/or other aspects are not to be considered limitations on the disclosure as defined by the claims or limitations on equivalents to the claims.

### Capital Management Product Enrollment System Controller

FIG. 1 is of a block diagram illustrating non-limiting embodiments of aspects of a Capital Management Product Enrollment System (CMPES) controller 101. In this embodiment, the CMPES controller 101 may serve to generate, process, store, search, serve, identify, instruct, match, and/or update data.

Typically, users, which may be people and/or other systems, engage information technology (IT) systems, which are commonly computers, to facilitate information processing. Many of these computers employ processors to process information; such processors are often referred to as central processing units (CPU). A common form of processor is referred to as a microprocessor. A computer operating system (OS), which, typically, is software executed by a CPU on a computer, enables and facilitates users to access and operate computer IT, resources, and data. Common resources employed in IT systems include: input and output mechanisms through which data may pass into and out of a computer; memory storage into which data may be saved; and processors by which information may be processed. Often IT systems are used to collect data for later retrieval, analysis, and manipulation, which is commonly facilitated through database software. IT systems provide interfaces that allow users to access and operate various system components.

In one embodiment, the CMPES controller 101 may be connected to and/or communicate with entities such as, but not limited to, one or more users or systems through user input devices 111; peripheral devices 112; communications network 113; and/or cryptographic processor devices 128.

Networks are commonly thought to comprise the interconnection and interoperation of clients, servers, and intermediary nodes in a graph topology. It should be noted that the term “server” as used throughout this disclosure refers generally to a computer, other device, software, or combination thereof that provides services to other computers. A server may process or respond to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destination points. A node specifically tasked with furthering the passage of information from a source to a destination is commonly called a “router.” There are many forms of networks such as Local Area Networks (LANs), Pico networks, Wide Area Networks (WANs), Wireless Networks (WLANs), Personal Area Networks (PANs), and/or the like. For example, the Internet is generally accepted as being an interconnection of a multitude of networks whereby remote clients and servers may access and interoperate with one another.

A CMPES controller 101 may be based on common computer systems that may comprise, but are not limited to, components such as: a computer systemization 102 connected to memory 123.

### Computer Systemization

A computer systemization 102 may comprise a clock 130, CPU 103, a read only memory (ROM) 106, a random access memory (RAM) 105, and/or an interface bus 107, and most frequently, although not necessarily, are all interconnected and/or communicating through a system bus 104. Optionally, the computer systemization may be connected to an internal power source 186. Optionally, a cryptographic processor 126 may be connected to the system bus 104. A system clock 130 may be used with the computer systemization. A system clock typically has a crystal oscillator and provides a base signal. The clock 130 is typically coupled to the system bus 104 and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or connected through another device that is connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron, Turion, Sempron, and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the CMPES Controller 101 and beyond through various interfaces. Should processing requirements dictate a greater amount of speed, parallel, mainframe and/or super-computer architectures may similarly be employed. Alternatively, should deployment requirements dictate greater portability, smaller systems may be employed including Personal Digital Assistants (PDAs) and/or the like. Alternatively, any device capable of performing similar or comparable functions may be employed.

### Power Source

The power source 186 may be of any standard form for powering small electronic circuit board devices such as the following power cells: alkaline, lithium hydride, lithium ion, nickel cadmium, solar cells, and/or the like. Other types of alternating current (AC) or direct current (DC) power sources may be used as well. In the case of solar cells, in one embodiment, the case provides an aperture through which the solar cell may capture photonic energy. The power source 186 is connected to at least one of the interconnected subsequent components of the CMPES controller thereby providing an electric current to all subsequent components. In one example, the power source 186 is connected to the system bus component 104. In an alternative embodiment, an outside power source 186 is provided through a connection across the Input Output (I/O) interface 108. For example, a Universal Serial Bus (USB) and/or IEEE 1394 connection carries both data and power across the connection and is therefore a suitable source of power.

### Interface Adapters

Interface bus(ses) 107 may accept, connect, and/or communicate with a number of interface adapters, conventionally, although not necessarily, in the form of adapter cards, such as but not limited to one or more: I/O 108, storage interfaces 109, network interfaces 110, and/or the like. Optionally, cryptographic processor interfaces 127 similarly may be connected to the interface bus. The cryptographic processor interface in turn may connect and/or communicate with a cryptographic device 128. The interface bus 107 provides for the communications of interface adapters with one another as well as with other components of the computer systemization. Interface adapters are adapted for a compatible interface bus. Interface adapters conventionally, although not necessarily, connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 109 may accept, communicate, and/or connect to a number of storage devices such as, but not limited to: storage devices 114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 110 may accept, communicate, and/or connect to a communications network 113. Network interfaces may employ connection protocols such as, but not limited to: direct connect, Ethernet (thick, thin, twisted pair 10/100/1000 Base T, and/or the like), Token Ring, wireless connection, such as IEEE 802.11a-x, and/or the like. A communications network may be any one and/or the combination of the following: a direct interconnection; the Internet; a Local Area Network (LAN); a Metropolitan Area Network (MAN); a Personal Area Networks (PAN); an Operating Missions as Nodes on the Internet (OMNI); a secured custom connection; a Wide Area Network (WAN); a wireless network (e.g., employing protocols such as, but not limited to, a Wireless Application Protocol (WAP), I-mode, and/or the like); and/or the like. A network interface may be regarded as a specialized form of an input output interface. Further, multiple network interfaces 110 may be used to engage with various communications network types 113. Such communications networks 113 may provide, for example, input and/or output from and/or to a user, and/or the like. For example, multiple network interfaces may be employed to allow for communication over broadcast, multicast, and/or unicast networks.

A communications network in one embodiment of the invention may be the Internet. The Internet is a worldwide, publicly accessible, data-transmitting network of interconnected computer networks. This “network of networks” transmits and provides a variety of information and services to users accessing the Internet. This information and these services provided via the Internet may be organized and/or accessed through use of an organizational construct, such as the World Wide Web. The Web is a global, read-write data space on the Internet. Text documents, images, video, sound, other multimedia and information, and/or any combination may be provided via the Web. These resources may be identified, found, accessed, cross-referenced, and provided through unique global identifiers called Uniform Resource Identifiers (URIs) or Uniform Resource Locators (URLs), which provide means for identifying and locating a resource. A Web browser, as discussed below, may be used to retrieve information resources on the Web using URLs or hyperlinks to access a desired resource on the Web.

Among the many communications protocols existing on and employed through the Internet, Transmission Control Protocol-Internet Protocol (TCP/IP) provides a set of standard rules for data representation, signaling, authentication, and/or error detection used to send information over a communications channel in one or more networks. TCP/IP allows for information to be routed through a variety of channels of a communications network from a source address to a destination address. The Internet is a packet-switched network. Information is broken into packets and transmitted in this form. These packets may contain IP addressing information called “headers,” which may be used by routers to facilitate the delivery of the packets from a source to a destination across intermediary nodes on the Internet. These packets are then reassembled upon arrival at the destination to form the original information. Any missing packets may be requested again to fill gaps in the information. The IP component of the protocol is a network layer protocol providing the service of communicable unique global addressing amongst computers and is responsible for routing packets of information using a four byte addressing logic. The TCP component of the protocol is used for verifying that packets of information are correctly received by the destination computer from the source. If the information is not correct, TCP may be used to retransmit packets. Using TCP, applications on networked hosts can create connections to one another, over which they can exchange data in packets. This protocol ensures reliable and in-order delivery of data from sender to receiver. TCP also distinguishes data for multiple, concurrent applications (e.g. Web server and e-mail server) running on the same host. TCP is the intermediate layer between the IP below it, and an application above it. Other communications protocols are also commonly used, including but not limited to: the e-mail protocol Simple Mail Transfer Protocol (SMTP), User Datagram Protocol (UDP), point-to-point protocol (PPP), and/or the like.

I/O 108 may accept, communicate, and/or connect to user input devices 111, peripheral devices 112, cryptographic processor devices 128, and/or the like. I/O may employ connection protocols such as, but not limited to: Apple Desktop Bus (ADB); Apple Desktop Connector (ADC); audio: analog, digital, monaural, RCA, composite, stereo, surround, and/or the like; IEEE 1394a/b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) or any similar device that accepts signals from a video interface may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 111 may be card readers, dongles, finger print readers, gloves, graphics tablets, joysticks, keyboards, mouse (mice), remote controls, retina readers, microphones, trackballs, touchpads, and/or the like.

Peripheral devices 112 may be connected and/or communicate with I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the CMPES controller 101 may be embodied as an embedded, dedicated, and/or monitor-less (i.e., headless) device, wherein access would be provided over a network interface connection.

Cryptographic units such as, but not limited to, microcontrollers, processors 126, interfaces 127, and/or devices 128 may be attached, and/or communicate with the CMPES controller 101. For example, a MC68HC16 microcontroller, commonly manufactured by Motorola Inc., may be used for and/or within cryptographic units. Equivalent microcontrollers and/or processors may also be used. Cryptographic units support the authentication of communications from interacting agents, as well as allowing for anonymous transactions. Cryptographic units may also be configured as part of a CPU. Other commercially available specialized cryptographic processors include VLSI Technology's 33 MHz 6868 or Semaphore Communications' 40 MHz Roadrunner 184.

### Memory

Generally, any mechanization and/or embodiment allowing a processor to affect the storage and/or retrieval of information is regarded as memory 123. However, memory is a fungible technology and resource, thus, any number of memory embodiments may be employed in lieu of or in concert with one another. It is to be understood that a CMPES controller 101 and/or a computer systemization may employ various forms of memory 123. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 123 will include ROM 106, RAM 105, and a storage device 114. A storage device 114 may be any conventional computer system storage. Storage devices may include a drum; a (fixed and/or removable) magnetic disk drive; a magneto-optical drive; an optical drive (i.e., CD ROM/RAM/Recordable (R)/ReWritable (RW), DVD ROM/RAM/Recordable (R)/ReWritable (RW), Blu-ray Disc, HD DVD, etc.); and/or other devices of the like. Thus, a computer systemization generally requires and makes use of memory.

### Module Collection

The memory 123 may contain a collection of program and/or database modules and/or data such as, but not limited to: operating system module(s) 115 (operating system); information server module(s) 116 (information server); user interface module(s) 117 (user interface); Web browser module(s) 118 (Web browser); database(s) 119; cryptographic server module(s) 120 (cryptographic server); CMPES module(s) 135; and/or the like (collectively, a module collection). These modules may be stored and accessed from the storage device(s) and/or from storage devices accessible through an interface bus 107. Although non-conventional software modules such as those in the module collection typically are stored in a local storage device 114, they may also be loaded and/or stored in memory such as: peripheral devices, RAM, remote storage facilities through a communications network, ROM, various forms of memory, and/or the like. pursue

### Operating System

The operating system (OS) module 115 is executable program code facilitating the operation of a CMPES controller 101. Typically, the OS facilitates access of I/O, network interfaces, peripheral devices, storage devices, and/or the like. The OS may be a highly fault tolerant, scalable, and secure system such as Apple Macintosh OS X (Server), AT&T Plan 9, Be OS, Linux, Unix, and/or the like. However, more limited and/or less secure operating systems also may be employed such as Apple Macintosh OS, Microsoft DOS, Palm OS, Microsoft Windows 2000/2003/3.1/95/98/CE/Millenium/NT/XP, and/or the like. An OS may communicate to and/or with other modules in a module collection, including itself, and/or the like. Most frequently, the OS communicates with other program modules, user interfaces, and/or the like. For example, the OS may contain, communicate, generate, obtain, and/or provide program module, system, user, and/or data communications, requests, and/or responses. The OS, once executed by the CPU, may enable the interaction with communications networks, data, I/O, peripheral devices, program modules, memory, user input devices, and/or the like. The OS may provide communications protocols that allow the CMPES controller 101 to communicate with other entities through a communications network 113. Various communication protocols may be used by the CMPES controller 101 as a subcarrier transport mechanism for interaction, such as, but not limited to: multicast, TCP/IP, UDP, unicast, and/or the like.

### Information Server

An information server module 116 is stored program code that is executed by the CPU. The information server may be a conventional Internet information server such as, but not limited to Apache Software Foundation's Apache, Microsoft's Internet Information Server, and/or the like. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server may resolve requests for information at specified locations on a CMPES controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the CMPES database 119, operating systems, other program modules, user interfaces, Web browsers, and/or the like.

Access to the CMPES database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CMPES. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard Structured Query Language (SQL) by instantiating a search string with the proper join/select commands based on the tagged text entries, wherein the resulting command is provided over the bridge mechanism to the CMPES as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

In one embodiment, the information server and/or Web content portion of the CMPES may not communicate directly with the CMPES database 119. A web service may be created and used as a data services layer. This layer will receive method calls from one or more Websites and return dataset objects. An Application Programming Interface (API) specification may be generated that will outline the required methods, parameters, dataset schemas, and/or the like. An API is an interface that a computer system, library, and/or application may provide in order to allow requests for services to be made of it by other computer programs and/or systems, and/or to allow data to be exchanged between them. The API may describe how computer applications and/or software developers may access one or more sets of functions (for example, within a library or database) without requiring direct access to the source code of the functions or data, or requiring a detailed understanding of the functions' internal workings.

Also, an information server may contain, communicate, generate, obtain, and/or provide program module, system, user, and/or data communications, requests, and/or responses.

### User Interface

A user interface is an aggregate of means by which one or more users may interact with a particular device, system, application, CPU, and/or the like. A user interface may facilitate the communication between the user and a device, system, application, CPU, and/or the like being accessed. The function of computer interfaces, in some respects, is similar to automobile operation interfaces. Automobile operation interface elements such as steering wheels, gearshifts, gauges, lights, and other displays facilitate the access, operation, and display of automobile resources, functionality, information, and status. Computer interaction interface elements such as text boxes, check boxes, cursors, menus, buttons, scrollers, and windows (collectively and commonly referred to as widgets) similarly facilitate the access, operation, and display of data and computer hardware and operating system resources, functionality, information, and status. Operation interfaces are commonly called user interfaces. Graphical user interfaces (GUIs), such as the Apple Macintosh Operating System's Aqua, Microsoft's Windows XP, Unix's X-Windows, and/or the like, provide a baseline and means of accessing and displaying information graphically to users.

A user interface module 117 is stored program code that is executed by the CPU. The user interface may be a conventional GUI as provided by, with, and/or atop OSs and/or operating environments such as Apple Macintosh OS (e.g., Aqua), Microsoft Windows (e.g. NT/XP), Unix X-Windows (e.g. CDE, KDE, Gnome, and/or the like), Linux, mythTV, and/or the like. The user interface may allow for the display, execution, interaction, manipulation, and/or operation of program modules and/or system facilities through textual and/or graphical facilities. The user interface provides a facility through which users may affect, interact with, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

### Web Browser

A Web browser module 118 is stored program code that is executed by the CPU for the access of information. The Web browser may be a conventional hypertext viewing application such as Microsoft Internet Explorer or Mozilla Firefox. Secure Web browsing may be supplied with 128-bit (or greater) encryption by way of HTTPS, SSL, and/or the like. Some Web browsers allow for the execution of program modules through facilities such as Java, JavaScript, ActiveX, and/or the like. Web browsers and like information access tools may be also integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; for example, it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from CMPES enabled nodes. The combined application may be nugatory on systems employing standard Web browsers.

### Cryptographic Server

A cryptographic server module 120 is stored program code that is executed by the CPU 103, cryptographic processor 126, cryptographic processor interface 127, cryptographic processor device 128, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (which is a one way hash function) (MD5), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), HTTPS, and/or the like. Employing such encryption security protocols, the CMPES controller may encrypt all or part of incoming and/or outgoing communications and may serve as a node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, for example, employing MD5 hash function to obtain a unique signature for a digital audio file. A cryptographic module may communicate to and/or with other modules in a module collection, including itself, and/or facilities of the like. The cryptographic module supports encryption schemes allowing for the secure transmission of information across a communications network to enable a CMPES module to engage in secure transactions if so desired. The cryptographic module facilitates the secure accessing of resources on CMPES and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

### CMPES Database

A CMPES database module 119 may be embodied in one or more databases and stored data. The database is stored program code, which is executed by the CPU; the stored program code portion configuring the CPU to process the stored data. A database may implement a database management system, relational database management system, or other system and/or software designed to manage a database and/or run operations on the data requested by numerous clients and/or users. For example, the CMPES database 119 may operate in a Microsoft SQL Server environment. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CMPES database 119 may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the CMPES database 119 is implemented as a data-structure, the use of the CMPES database 119 may be integrated into another module such as the CMPES module 135. Also, the database may be implemented as a mix of data structures, objects, and relational structures. Databases may be consolidated and/or distributed in countless variations through standard data processing techniques. Portions of databases, for example, tables, may be exported and/or imported and thus decentralized and/or integrated.

In one embodiment, the CMPES database module 119 includes several tables 119a-d. A users table 119a includes fields such as, but not limited to: a user name, address, user_id, user_status, and/or the like. The users table 119a may also include data regarding how the user is associated with a given system and/or process and/or may include information concerning the proposals, customers, and/or the like with which the user is or may be associated. The users table may support and/or track multiple entity accounts on a CMPES. An accounts table 119b may include fields such as, but not limited to: account_id, admin_user_id (a user given administrative status to control the account), account_level, account_info, account_number, account_type, account_portfolio_data, and/or the like. A customer_information table 119c may include fields such as, but not limited to: customer_id, customer name, date, customer rofile, customer_security_information, associated_financial_advisor, associated_financial_specialist, associated_partner_bank, associated_partner_administrator, associated_vendor, status, and/or the like. A proposal_information table 119d may include fields such as, but not limited to: proposal_status, proposal_criteria, proposal_info, proposal_attributes, proposal_services, recommended_package, proposal_estimates, proposal rice_estimates, proposal_volumetric_estimates, pricing_data, amendment_data, enrollment_info, and/or the like. This embodiment is one of many of possible embodiments of CMPES Database module 119 and is not exhaustive and/or exclusive. Certainly other tables may be used in addition or as an alternative to one or more of these tables.

In one embodiment, the CMPES database may interact with other database systems. For example, employing a distributed database system, queries and data accessed by CMPES modules may treat the combination of the CMPES database and an integrated data security layer database, as a single database entity.

In one embodiment, user programs may contain various user interface primitives, which may serve to update the CMPES. Also, various accounts may require custom database tables depending upon the environments and the types of clients a CMPES embodiment may serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of a decentralized database controllers may be varied by consolidating and/or distributing one or more of the various database modules 119a-d. The CMPES may be configured to keep track of various settings, inputs, and parameters via database controllers.

A CMPES database may communicate to and/or with other modules in a module collection, including itself, and/or the like. Most frequently, the CMPES database communicates with a CMPES module, other program modules, and/or the like. The database may contain, retain, and provide information regarding other nodes and data.

### CMPES

A CMPES module 135 is stored program code that is executed by the CPU 103. The CMPES affects accessing, obtaining, and the provision of information, services, transactions, and/or the like across various communications networks.

The CMPES enables methodologies for the selection and/or preparation of suitable capital management products. The CMPES receives inputs from various systems and/or users in communication with the CMPES and coordinates with the CMPES database to perform a variety of functions, including but not limited to the selection, preparation, and/or enrollment of a customer in an appropriate capital management product.

A CMPES module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. In one embodiment, the CMPES server employs a cryptographic server to encrypt and decrypt communications. A CMPES module may communicate to and/or with other modules in a module collection, including itself, and/or facilities of the like. Most frequently, the CMPES module communicates with a CMPES database, operating systems, other program modules, and/or the like. The CMPES may contain, communicate, generate, obtain, and/or provide program module, system, user, and/or data communications, requests, and/or responses.

### Distributed CMPES

The structure and/or operation of any of the CMPES node controller components may be combined, duplicated, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. Conversely, multiple instances may exist in a single controller and/or storage device and include one or more additional components discussed herein and/or known in the art. All program module instances and controllers working in concert may do so through standard data processing communication techniques.

The preferred configuration of the CMPES controller will depend on the context of system deployment. Factors such as, but not limited to, the budget, capacity, location, needs, users, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: API information passage; (distributed) Component Object Model ((D)COM), (Distributed) Object Linking and Embedding ((D)OLE), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The CMPES controller 101 enables the implementation of a CMPES, the selection and/or preparation of a suitable capital management product, and the facilitation of multiple user procedures, inputs, and/or communications. A CMPES controller may enable, separately or in conjunction with one another, the profiling of a customer and the proposal, enrollment, amendment, and/or activation of a capital management product (e.g., a lockbox tool).

It is to be understood that the logical and/or topological structure of any combination of the module collection and/or the present system as described in the figures and throughout herein are not limited to a fixed execution order and/or arrangement, but rather, any disclosed order is exemplary and all functional equivalents, regardless of order are contemplated by the disclosure. Furthermore, it is to be understood that such structures are not limited to serial execution, but rather, any number of threads, processes, services, servers, and/or the like that may execute asynchronously, simultaneously, synchronously, and/or the like are contemplated by the disclosure.

### Capital Management Products

A capital management product is any technique, system, or product that provides some control, routing, or manipulation of capital (e.g. cash), usually in an effort to meet certain needs of and/or specifications desired by a user or customer. A capital management product may also be known as a capital management system or cash management system. These systems may also be referred to as capital management products, cash management products, and/or the like. These terms and others may be used interchangeably in describing a system or product meeting these characteristics. Typically, capital management products are utilized for or by companies in an attempt to efficiently manage, direct, or mobilize their assets, cash, receivables, and/or the like. Such a product may be used to efficiently manage receivables, cash, credits, payments to creditors, and/or the like.

For example, a company may collect funds from many different accounts and place them into a single concentration account and invest a given amount of funds designated as excess funds into an income producing application, such as a money market account, savings account, and/or the like. Optionally, the account may be drawn down to zero-funds each day.

Another example of a capital management product may involve controlling the outflow of funds in disbursing payments to creditors by timing payments with the receipt of invoices from creditors.

Another frequently used tool in cash management is a controlled disbursement of company payments to match the collection of accounts receivables against disbursements to trading partners.

A capital management product may use human input, computers, computer networks, telecommunications technology, and/or the like to efficiently manage a user's or customer's (e.g. a company) capital in reaching a desired outcome. It is to be understood that there are numerous types of capital management products, each with its own structure and utility. Although all examples of capital management products have not been listed or described herein, all like systems, tools, or processes are contemplated by this disclosure.

A lock box is one type of capital management product whereby the payments of one or more payors to a company (typically, but not necessarily, customers of the company) are processed for the company. This processing of payments may be performed internally, by the company, or be outsourced and performed by a third party, such as, for example, a bank. These payments may be processed in any form that achieves the results desired by the company. In a lock box, a company's payors may send payments that are owed to the company to a central repository. There are a variety of resources that may serve as a central repository, including one or more of the following: a post office box, a mailing address, an account with a financial institute (e.g. a checking account, a savings account, a bank account, an offshore account, an online account, a demand deposit account, and/or the like), and/or the like. One example would be the collection of checks from customer-payors of a company to a post office box. Checks may be routed to a designated post office box number, where they are received and held until collected. The checks may then be processed, including, but not limited to, separating the checks from the envelopes, cross referencing against invoices, bills or other related documents, deriving information, and submitting the check to a check collection system for conversion into cash receivables. Once these payments are collected, the value retained from these payments may then be used to fund a deposit account for the company for which the payments were intended. The company may be updated about the payments made by the company's payors and the deposits into the company's account as well as other desired information related to the transaction.

An advantage of the lockbox system is that it may reduce processing float, which is the time between the deposit of a payment into an account and the actual funds from that payment being transferred to or available in the account, and may provide cash for the company to work with more quickly.

Lock boxes come in a variety of applications, including, but not limited to retail, designed for remittance processing for consumer accounts, and wholesale, in which payments from other companies are collected and submitted through depository transfer check or electronic debit into a concentration account for investment and disbursement as needed.

It is of course understood that throughout the discussion herein, reference to a capital management product or system applies equally to such products as a lockbox product or system and/or the like, which is considered one type of capital management product or system.

### Existing Enrollment Processes

As stated above, there are a large number of capital management products currently in use. Many of these systems are managed and operated by third parties who take care of the processing involved and provide the outcome desired of the capital management product. In a capital management product managed and operated by a third party, the party for whom the system is operated may be considered a customer or client of the third party and so will be referred to as such herein. There are of course other names which may be applied that are not specifically listed herein.

In each type of capital management product, a party must be enrolled into the system. This may entail selecting the proper system and related options, preparing proposals for customers regarding the system, and communication among the parties to arrive at a suitable capital management solution. Typically, but not necessarily, the capital management product in which a party (customer) enrolls is operated or administered by a third party. More parties may be involved in a capital management product or the enrollment of a customer into such a product.

There are many ways in which a customer may be enrolled into a capital management product operated by a third party. In some situations, there may be no specific process for enrollment. In other situations, there may be established processes, but they are typically primarily manual processes and human-input intensive.

One example of an existing enrollment process for a lockbox product involves a client, an advisor, and a partner administrator. FIG. 2 provides an illustration of this example. The three parties involved in this process use various forms of communication and computer systems during this enrollment process. As FIG. 2 illustrates, this enrollment process begins with (1) a request by a Client for a lockbox product to an Advisor. The Advisor then will typically (2) retrieve the necessary and/or customary information about the Client and the Client's needs.

The Advisor may then (3) communicate the information to a Partner Administrator. In this example, the Partner Administrator would ultimately take care of the administration of the lockbox product for the Client. Once the Partner Administrator has sufficient information, it may (4) determine what the proper lockbox product would be for the Client and the Client's particular situation. The Partner Administrator may then (5) send a proposal to the Advisor outlining the details of the selected lockbox product. The Advisor may then (6) relay this proposal to the Client and discuss any of the details with the Client.

The Client may then decide to reject or accept the proposal. If the decision is to accept, the Client may then (7) relay this acceptance to the Advisor. The Advisor may then (8) obtain a Client signature authorizing the creation and operation of the lockbox product for the Client. Once the Client has signed, the Advisor may (9) send the approved proposal to the Partner Administrator. The Partner Administrator may now (10) establish the necessary pieces and steps for the approved lockbox product to operate. This may include establishing accounts, central repositories, processing routes, and/or other optional pieces of a lockbox product. Upon completion of the lockbox product, the (11) account information is sent to the Advisor who may then (12) relay such information to the Client and inform the Client that the account is available for use.

This is of course a generalized description of the process highlighting some of the main steps of an existing process. This example does not discuss many of the various tasks that take place in association with and/or between each listed task.

### Capital Management Product Enrollment System

The novel enrollment system of this invention comprises an online customer data collection, an automated profile analysis, capital management product selection, and client proposal processes. The selection of an appropriate capital management product, the generation of the client proposal, and the generation of a Partner Administrator capital management product application may be performed by this CMPES. The CMPES may also generate system messages to the parties involved, replacing the need for many of the communications among the parties and/or systems involved in a typical enrollment process.

In one embodiment, which would apply to the situation as described above in relation to existing enrollment processes was discussed, a CMPES may comprise the following steps. This is of course one representative embodiment of a CMPES and is not exhaustive of all possible variations of a CMPES. In this embodiment, the CMPES initiates the enrollment process with the entry of a request for a capital management product by a user, typically on behalf of a customer. A user may enter or retrieve basic customer information and profile data into the system. Optionally, a user may access other systems for customer information and profile data. The CMPES may then analyze the customer profile data to select either a pre-defined capital management product package or a custom-designed capital management product package. The user can discuss additional options, which may optionally be selected and/or implemented through the CMPES, with the client.

If the CMPES recommends a pre-defined package, the details of the package may be determined from the system pricing parameters. The CMPES may generate a packaged client proposal about the recommended pre-defined package, which can be viewed, printed and/or downloaded by any party.

If the CMPES recommends a custom priced package, a system message (e.g. an e-mail) may be generated by the system and sent to an administrator to create a custom priced package. The CMPES may optionally provide information to the administrator sufficient to create the custom priced package or provide means by which the administrator may access such information. After generating a custom priced package, the administrator may upload the details of the generated package to the CMPES. Optionally, an administrator may be an external party, a separate entity from the user operating the system; a Partner Administrator. This option is discussed herein. However, it should be understood that such Partner Administrator operations may take place using an internal administrator, or party more directly associated with the user of the system.

Once a capital management system package is selected or generated, a proposal may be created for the customer. This proposal may comprise pre-defined contents and custom-designed contents. Changes may be made to the proposal, including the recommended products or information, in the CMPES. Optionally, some changes may be made to the proposed products or information after the proposal is generated. Alternatively, some changes may be considered proposal revisions and result in the generation of a new proposal automatically. This method may be useful to maintain the integrity of a recommended product or proposal. Certain changes may impact the operation of a capital management product. Generating a new proposal may assist in accounting for such ramifications.

If the client chooses to accept the proposal, a user (e.g. a customer advisor) may complete the entry of remaining customer data into the CMPES and use the system to complete an enrollment application, which may be viewed by the user and others using the system. Once an enrollment application is completed, a capital management product administrator may access the enrollment information on or using the system and, optionally, the system may be used in the preparation of the capital management product.

Some changes made after the proposal is accepted may be implemented using the CMPES. Alternatively or additionally, changes may be considered an amendment to the accepted proposal. If the changes are considered a proposal amendment, the CMPES may generate an amendment document for additional processing by the system and/or review, input, acceptance and/or the like by the parties involved in the process.

Once the structure of a capital management product is generated, a user (customer, administrator, advisor, and/or the like) may enter the pertinent details about the customer and the customer's situation into the capital management product structures using the CMPES to make the product operational. The CMPES may send system message notifications to the appropriate parties, as may be defined in the system, and may also trigger a system message to send introductory information or a welcome kit to the customer to begin the customer's use of the capital management product.

If the customer chooses not to accept the proposal, an advisor may update the status of the account in the CMPES and may enter a reason for the rejection. Additionally, there may be an option to cancel the capital management product request at any point during operation of the CMPES. One or more cancellation reasons may be entered, if the process is indeed cancelled. The client may additionally or alternatively request a custom proposal for a capital management product.

The CMPES provides centralized access to a multitude of functions and associated data. Access to these functions and this data by users of the system may be restricted to prevent its disclosure to or access by unintended parties. In one embodiment, access to certain data types may be managed using permission levels set up for each involved party's role in the process. For example, a user may be given a very restricted permission level, preventing them from accessing such functions and data as information about other users and/or regarding the data and operations of the system, operator, administrator, and/or the like.

### Centralized Capital Management Product Enrollment System

The CMPES provides an organized and centralized structure for the enrollment of a party into a capital management product. A centralized CMPES may communicate with one or more parties associated with the enrollment process. Each of these parties may have its own, specifically defined relationship with the system. This centralized structure does not require however that all aspects of the invention exist in one physical location, node, server, database, processor, computer system, and/or the like.

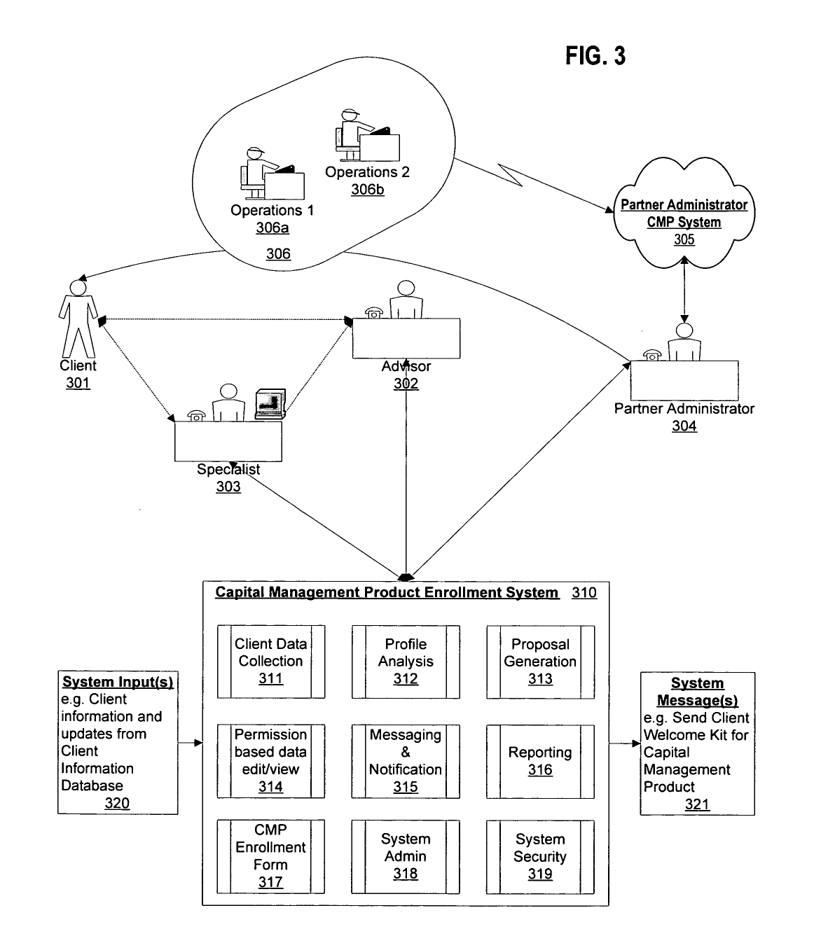

FIG. 3 provides an illustrative example of an embodiment of the CMPES, showing the relationships between and among the various parties involved in a capital management product enrollment and the CMPES. FIG. 3 also illustrates where inputs into the CMPES may come from and to whom certain outputs from the CMPES may go. Each of these relationships and the CMPES will be explained in greater detail herein. This illustration is merely of a representative embodiment of a CMPES. This one of many applications of a CMPES. For the convenience of the reader, all possible embodiments are not discussed herein. This illustration may be useful in providing a context in which the reader may better understand many of the embodiments discussed herein.

In FIG. 3, the Client 301 may communicate with an Advisor 302. Through this relationship, the Client 301 may request a Capital Management Product, approve a proposal, and communicate information, including preferences, statistics, financial information, and/or the like, with the Advisor 302. Optionally, the Client 301 may also communicate with a Specialist or some other party 303, which may be involved in the process. A Partner Administrator 304 may also be associated with the Capital Management Product and/or enrollment process.

The Advisor 302, Specialist 303, and/or Partner Administrator 304 may communicate with the CMPES 310 to initiate, continue, amend, and/or terminate an enrollment process, as well receiving output and/or feedback from the CMPES 310. The Partner Administrator 304 may also optionally communicate with one or more Operations units 306 (represented as 306a and 306b, but more Operations 306c, 306d, etc. units may exist and operate with the CMPES) and, optionally, with the Client 301. The Partner Administrator 304 may instruct an Operation unit 306 to manage certain tasks related to an enrollment. Optionally, a Partner Administrator 304 may communicate with one or more Partner Administrator Capital Management Product Systems 305, which may also receive input from one or more Operations units 306.

The CMPES 310 in this embodiment depicts some of the many functions provided by a CMPES. The functions listed relate to the communication of various parties with the CMPES 310. The CMPES 310 in this case receives inputs of data from an Advisor 302, a Specialist 303, and/or a Partner Administrator 304, including data about the Client 301 and the Client's situation, proposals and amendments, general preferences, and/or any other inputs associated with an enrollment using the CMPES 310. The functional components listed in this embodiment of the CMPES 310 provide for Client Data Collection 311, Profile Analysis 312, Proposal Generation 313, the access (edit/view) of data based on permission levels 314, Messaging and Notification 315, Reporting 316, an enrollment form for a capital management product 317, System Administration 318, and System Security 319. The functions listed in these components of this embodiment of a CMPES 310 relate generally to the communication of the CMPES 310 with the various parties and/or systems related to the enrollment process using this system. It should be understood that there are other functional components that may be a part of a CMPES 310.

The Client Data Collection component 311 allows the CMPES 310 to receive data input by one or more users or systems and maintains this data in memory for subsequent access and/or processing.

The Profile Analysis component 312 provides the CMPES 310 with the functionality to process data to which the system has access, either internally or remotely, to analyze one or more considerations relevant to an enrollment in an effort to recommend a capital management product for the given circumstance(s) being analyzed.

The Proposal Generation component 313 produces a basic proposal based on the recommended capital management product. This component may automatically generate based on the recommended capital management product. Portions of the proposal may be automatically completed based on the data that the system has access to. For example, an auto-fill operation may complete all client data known or accessible by the system. For further example, the system may automatically generate portions of the proposal that pertain to the capital management product and how it is designed or should function, and/or the like.

The Permission based data edit/view component 314 facilitates the regulation of information access rights for each user of the system. For example, in some situations, it may be useful to allow a user to modify certain data or even system components, whereas, in other situations, it may be proper to simply allow read-only access to one or more system components by a user. This may be used to regulate access to data, system components, and/or the like.

The Messaging and Notification component 315 allows the system to communicate with one or more persons and/or systems. This component may, for example, send a system message to an outside system to initiate the outside system's performance of a particular function or request additional input, send notifications to one or more users to update them as to the status of an enrollment, alert the relevant party of missing data or necessary steps that have not been taken or should be taken, and/or the like. For example, various email messages may be generated throughout a request for or enrollment into a capital management product and distributed to one or more users based on notification definitions, which may designate which user(s) should receive certain types of messages. In one embodiment, a message may be actionable, providing means through which the recipient may take additional steps, or information, providing information to the recipient.

The Reporting component 316 provides common reporting functionality to provide an account or summation of system data, components, enrollment stages, and/or the like. For example, a number of previously-established (canned) reports may be developed and stored on the system for subsequent access by the system and/or others. In one embodiment, a user interface may be provided that allows access to one or more of these canned reports through a variety of mediums, such as a list, dropdown menu, search question, filter criteria, field search, and/or the like. These reports may be generated and viewable via a video display, printable, modifiable, communicated as a data file, and/or the like.

The capital management product Enrollment Form component 317 facilitates the generation and completion of an enrollment form for a capital management product. This component may automatically generate an enrollment form based on stored data and forms, and provide the form to one or more users. Additional steps may be taken and/or modifications or additions made to the enrollment form once generated.

The System Administration component 318 and System Security component 319 provide typical system administration and security functions as known in the art. Through the System Administration component 318, the system may offer a variety of system administrative functions. For example, a system administrator may set and/or modify user access rights and account types, add, delete or modify documents and/or files on the system (including, for example, proposals, marketing documents, forms, questions, customer information, data files, previously-defined capital management products, etc.), account management, permission levels, user relationships, system relationships, communications data, and/or the like.

These components 311-319 will be discussed in greater detail in other embodiments herein and incorporate equivalent functions not specifically outlined herein. Additional components may also be implemented depending upon the embodiment as discussed herein. This is a list of representative components. All components will not be listed for the convenience of the reader.

The CMPES 310 also provides outputs of data, including instructions, information, system messages, and/or the like, to Advisors 302, Specialists 303, Operations 306 and/or a Partner Administrators 304. Data may also be transmitted from one or more System Inputs 320 and to system outputs through one or more System Messages 321. One example of data transmitted from a System Input 320 may be the communication of client data existing in a client information database to the CMPES 310. An example of data transmitted from CMPES 310 to a system output may be a System Message 321 to send a client welcome kit to the client for the Capital Management Product once it is authorized for operation.

This data may be input to and received from the CMPES 310 using any number of customary means including as discussed herein, such as through Communications Networks 113, Peripheral Device(s) 112, User Input Device(s) 111, and/or the like.

### Enrollment Stages

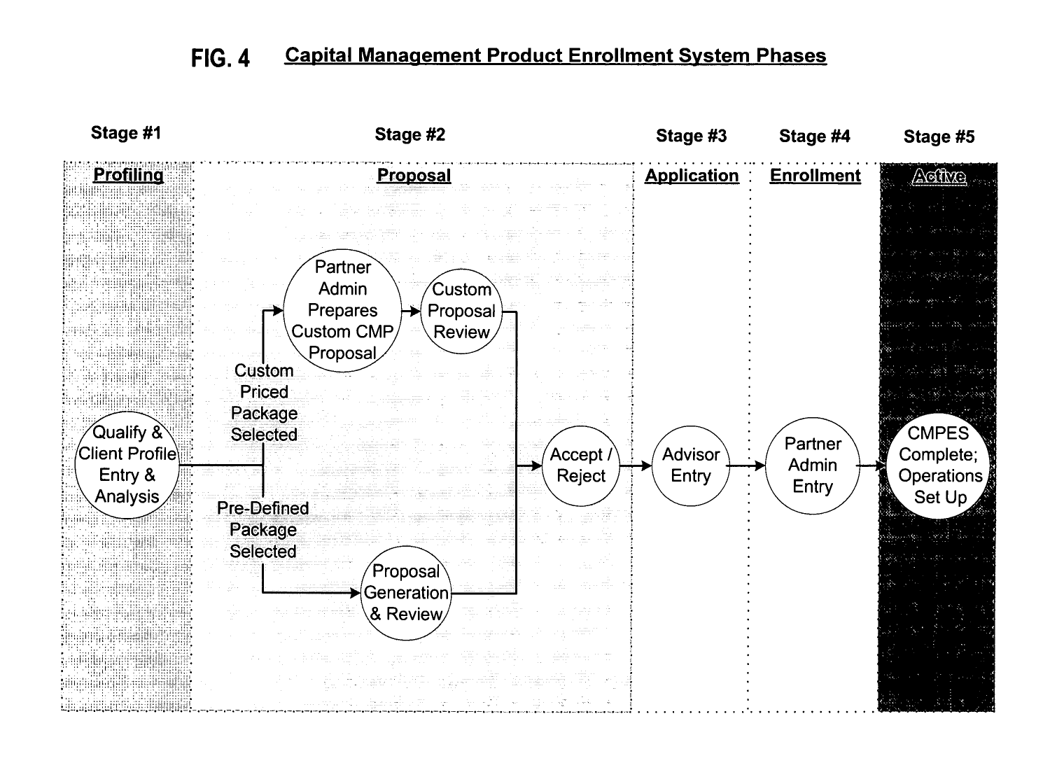

Below, certain embodiments of the CMPES are outlined in detail to provide further illustration of some embodiments of a CMPES. To aid in understanding the CMPES, the enrollment process may be viewed in stages. FIG. 4 provides an illustration of the operation of a CMPES broken into stages. These stages may be generally characterized in five stages: (1) Profiling and Recommendation Engine; (2) Proposal; (3) Application; (4) Enrollment; and (5) Active.

Stage 1, Profiling, which includes much of the initiation of the enrollment process and entry of initial data into a CMPES. In this illustration, a client requests a capital management product and it is determined whether the client and the client's situation qualify for a capital management product. It is also at this point that the client's profile and other data may be entered into the system for analysis.

Stage 2, Proposal, describes the phase where a capital management product is selected and/or designed to meet the client's situation and, if one is appropriate, a proposal describing the product to the client is given to the client for approval or rejection. In this illustration, the system may decide whether a pre-defined package may be proposed, given the circumstances, or a custom package should be created and proposed to the client. If a pre-defined package is selected, the system may generate, or be used to generate, a proposal for submission for review by the client. If a custom package is applicable, an administrator may be contacted by the system to generate a custom package proposal including custom pricing and services applicable to the customer's circumstances. This administrator may be internal or a third-party partner administrator. In the case of a partner administrator, the custom proposal may be reviewed internally before submission for review by the client. If a custom package is created, the system may generate, or be used to generate, a proposal for submission for review by the client. In either case, the proposal may be reviewed and submitted to a client and the client may then decide whether to accept the proposal or reject it.

Stage 3, Application, entails completing additional tasks and entering additional data sufficient to begin initiation and operation of the designated capital management product. In this illustration, if the proposal is accepted by the customer, an internal advisor or specialist may enter additional information into the system about the client and client's circumstances.

Stage 4, Enrollment, describes the phase where the capital management product is prepared for operation. In this illustration, the operations units (internal and/or external) and/or partner administrator may take the steps to enroll the customer into the proposed and accepted capital management product and completes the enrollment process.

Stage 5, Active, is where the CMPES designates an account as active and the capital management product is initiated for implementation and operation.

This general description associated with FIG. 4 is only representative of illustrative embodiments provided to teach the principles of this the CMPES. It is by no means exhaustive and alternate embodiments as understood by those skilled in the art are also contemplated by this disclosure.

### Profiling

A user may access the CMPES (e.g. by logging in) to initiate a capital management product request. This may be for the initiation of a capital management product for internal purposes or at the request and for the benefit of a third party customer. The user may enter data into the CMPES sufficient to provide a profile. This profile may be relied upon in the generation of a capital management product proposal. For example, if the user is generating a request for a customer, the user may submit data relevant to the customer's situation, including the customer's needs, preferences, volume, and/or the like. Additionally, data concerning the customer, including contacts, addresses, financials data, and/or the like, may be entered into the request.

In one embodiment, if the user provides identification to the CMPES, certain information may optionally be automatically entered into the system or the user may be routed to certain tasks or functions within the CMPES. For example, if the user initiating the request is a Specialist, once the Specialist provides identification, the Specialist may be routed to the tasks or functions associated with the Specialist's roll in the enrollment and certain information or statistics about the Specialist may be automatically generated by the system, taken from internal memory or systems external to the CMPES, for use in the enrollment. This Specialist may be automatically assigned to a capital management product request and then may be required to assign an Advisor to the request. Optionally, CMPES may assign other parties to a request. In one embodiment, once certain parties are assigned to a request, others may be automatically assigned to a request, including supervisors, managers, and/or other related parties. In another embodiment, to assign an individual to a request, a user may be presented with search option in a user interface that allows them to search for someone by providing certain properties of the individual, such as their first and last name, identification number, position title, and/or the like. The system may then retrieve a list of matching users along with some clarifying fields such as office location. Similarly, in one embodiment, if a request is being generated for a customer and the customer is an existing customer, CMPES may retrieve data from a customer information database and input part or all of this data into the request. This may be performed by identifying the customer to the system through any means of identification including the name of the company, account number, and/or the like. A search function as described above may be provided for locating one or more specific customers.

In one embodiment, the CMPES may present questions to the user in order to retrieve the information necessary for the process of selecting and/or generating the appropriate proposal. The profile questions may be reviewed with or by a customer to provide the necessary answers. The information provided in response to these questions may be reviewed by the user for accuracy and entered into the system. Additionally, the user and/or customer may choose optional services related to the capital management product that may be relevant to the proposal that will be later generated in response to the request. Estimates may be provided to allow for a more accurate estimate of the costs of certain optional services. In some cases, the volumes may be edited and in other cases, the volume will be based on the profile data. Optional services, such as, but not limited to, batch printing, data file transmission, bulk image web download, returned items report maintenance, data capture keystrokes, custom programming, physical storage, data storage, virtual batching, payment alerts, optical character recognition, and/or the like may be appended to or incorporated within a capital management product.

During the Profiling stage, the user may also work with a customer to answer a series of risk management questions, such as but not limited to questions concerning anti-money laundering and Patriot Act completion date. The answers to these questions may or may not be used to perform any business logic or calculation within the CMPES.

Some examples of questions which may be asked by a CMPES or which may provide useful information for consideration of a request are: What percentage of returned items are received through an existing capital management product? What do you expect to receive via your capital management product? Are there key clients that contribute a larger percentage of relevant items? Do you receive or expect to receive cash, cash equivalents, ACH wires, or foreign exchange items through your lockbox? What is the anticipated use of funds coming into the capital management product? What is the percentage of operating capital? Any number of questions or topics may be covered to provide the most appropriate information to the system and/or users for selecting and possibly generating a proposal regarding a capital management product.

At any point during this Profiling stage, a user may stop the input process and save the data entered, allowing for retrieval of such entered data at a later point and the continuation of the profiling at a later time.

When sufficient data has been entered, the user may complete the request and designate the profile complete.

### Profile Analysis

The data entered into the profile will be processed by the CMPES using defined business rules to determine what capital management product package is most appropriate for the situation and/or customer, if applicable. Depending upon the circumstances, the system may recommend a previously defined capital management product package or a custom capital management product package tailored to the relevant circumstances.

In one embodiment, the CMPES may incorporate one or more previously defined capital management product packages. These previously defined packages consist of one or several different variants of a capital management product applicable to certain defined situations. These packages may be designed at any point and loaded on to the CMPES for later retrieval when suitable for a client's needs. Once loaded, the system may analyze a client's data to determine whether one or more of the previously loaded packages are suitable for the client's needs. Exactly how these previously designed packages are constructed and/or generated depend upon the application of the CMPES, users of the system, and, likely, typical situations that are faced by the users of the system. For example, it is likely that a user would construct one of these templates for each of the more common or typical capital management products implemented.

When a custom package is requested by the CMPES, the system may send a request, and may send additional data, including customer information and why a custom proposal was requested, to the party creating the custom package proposal (e.g. a partner administrator). For security reasons, a request for a custom package may be sent with no additional information, requiring access to the system for any additional information. This custom package functionality allows the CMPES flexibility to not only efficiently provide pre-defined packages for more common situations, but also to address situations where the details of a situation do not fit within the constructs of a typical capital management product on the system.

Various forms of logic or decision-making may be used within the CMPES to determine what the most appropriate package is for the circumstances. Exactly what logic construct is applicable in a CMPES will depend ultimately upon the desired use and results of the CMPES. A logic may be created and loaded onto a CMPES for this application and may be updated or modified to alter how the system functions in this respect.

After the appropriate capital management product is determined by the system, the user will have the opportunity to review the package and pricing. If a bundled or non-bundled package was recommended, the system will allow the user to request a custom package and send a request to the partner administrator for a custom package proposal.

### Hypothetical Profile Analysis

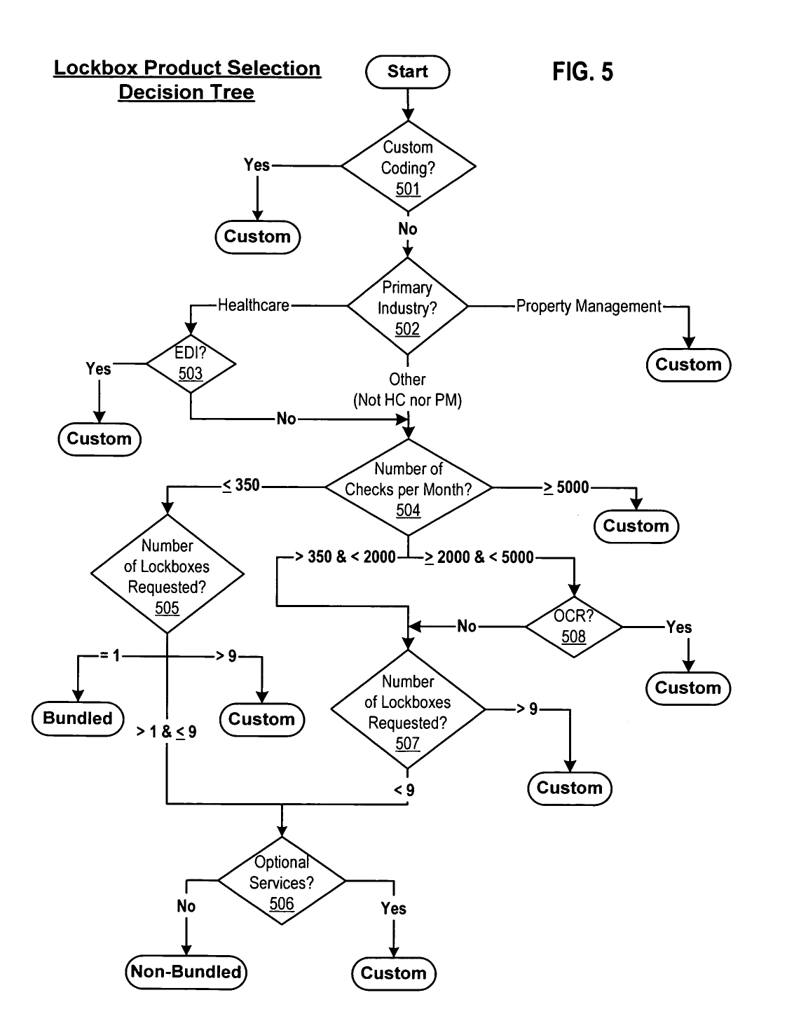

In one embodiment of a CMPES, the decision-making logic used during the enrollment process may be represented in a logic decision tree. FIG. 5 illustrates one example of a decision tree which may be used in a CMPES. This decision tree outlines how one embodiment of the CMPES may route an enrollment process. The decision tree or decision-making logic used within any given CMPES will depend upon the considerations of the user, the customer, the capital management product, and/or any of the parties or other considerations involved. It should be understood that this is only one of the many compatible logic constructs that may be employed within a CMPES and is provided for the convenience of the reader as an example to teach the principles of the system. This example may be expanded upon, simplified, duplicated, scaled, multiplied, and/or the like. It is not necessary that the specified considerations outlined in this decision tree be used within a CMPES, as long as some form of decision-making logic is applied.

The logic decision tree in FIG. 5 represents a sample of the decisions that a CMPES may go through when a request is made for a lockbox product. This decision tree begins with the question of whether custom coding is requested 501. If it is, the CMPES may generate a system message for the generation of a customized lockbox proposal. If it is not, the CMPES may look at the primary industry 502 in which the lockbox product will be used. In this case, two industries are highlighted as pertinent in the decision tree: healthcare and property management. There are, of course, a broad range of industries which may be considered depending upon the needs and/or use of a CMPES. If property management is the primary industry for which the lockbox product is intended, a system message may be generated and sent for the creation of a custom proposal. If healthcare is the primary industry for the use of the lockbox product, the decision tree then asks whether Electronic Data Interchange (EDI) is proper or requested 503. EDI is a computer-to-computer exchange of structured information, by agreed message standards, from one computer application to another by electronic means and with a minimum of human intervention. If EDI is requested by or proper for the customer, the CMPES may then generate a system message requesting the creation of a custom proposal. If EDI will not be used, this system will analyze how many checks are to be processed each month 504. If the lockbox is not intended for use in either the healthcare or property management industries, this system may not have specific considerations for the relevant industry. In this case, the system will analyze how many checks are to be processed each month 504.

If the number of checks to be processed is at least 5,000 or more, this system will request that a custom proposal be generated. If the amount of checks to be processed is 350 or fewer, the system may then assess how many lockboxes were requested 505 for this application. If only one (1) lockbox was requested, with 350 or fewer expected checks to be processed each month, the CMPES may then propose a previously defined, bundled lockbox. If greater than nine (9) lockboxes have been requested 505 for this application, the system may generate a system message requesting the generation of a customized lockbox proposal. For applications involving more than one (1), but no more than (9), lockboxes, this embodiment of a CMPES assesses whether different optional services are requested, preferred, and/or necessary 506 per lockbox. If the optional services are the same for this lockbox application, a previously defined, non-bundled lockbox may be proposed. If one or more different optional services are requested, preferred, and/or necessary 506 per lockbox, a system message requesting the generation of a customized proposal may be generated.

If the number of checks to be processed per month is in the range of more than 350 and fewer than 2,000, the system may then step to the next decision in the decision tree, which is to assess how many lockboxes are intended for this application 507. If greater than nine (9) lockboxes have been requested, the system may generate a system message requesting the generation of a customized lockbox proposal. For applications requiring fewer than nine (9) lockboxes, the system may assess whether different optional services are requested, preferred, and/or necessary 506 per lockbox. If the optional services are the same for this lockbox application, a previously defined, non-bundled lockbox may be proposed. If different optional services are requested, preferred, and/or necessary 506 per lockbox, a system message requesting the generation of a customized proposal may be generated.

If the number of checks to be processed per month is in the range of at least 2,000 and fewer than 5,000, the system may assess whether the lockbox product would include the additional steps of scanning images of the checks into a computer system and using optical character recognition (OCR) software to translate the images into a machine-readable and editable format. OCR computer software is designed to translate images, usually of handwritten or typewritten text, into a machine-readable and editable format and/or standard encoding scheme (e.g. ASCII, Unicode, and/or the like). These images may be produced by using a computer scanner communicatively attached to a computer system to copy the image of the document (in this case, a check), reproducing an image of the document, which may be saved in memory of a computer system and viewable on a monitor. The decision of whether to incorporate the OCR steps into the lockbox may be, for example, requested by the customer and/or user, or may be decided based on preferences outlined by the customer, user, or within the CMPES. If OCR steps are intended for this lockbox application, the system may generate a system message requesting the generation of a customized lockbox proposal including the OCR steps. If OCR steps are not intended for the lockbox application, the system may assess how many lockboxes are intended for this application 507. If greater than nine (9) lockboxes have been requested, the system may generate a system message requesting the generation of a customized lockbox proposal. If fewer than nine (9) lockboxes have been requested, the system may assess whether different optional services are requested, preferred, and/or necessary 506 per lockbox. If the optional services are the same for this lockbox application, a previously defined, non-bundled lockbox may be proposed. If different optional services are requested, preferred, and/or necessary 506 per lockbox, a system message requesting the generation of a customized proposal may be generated.

When a custom proposal is requested by the CMPES, the system may send sufficient data or provide access to such data, including why a custom proposal was requested, to the party creating the custom proposal (e.g. a partner administrator).

After the appropriate capital management product is determined by the system, the user will have the opportunity to review the package and pricing. If a bundled or non-bundled package was recommended, the system will allow the user to request a custom package and send a request to the partner administrator for a custom package proposal.

### Illustrative Example

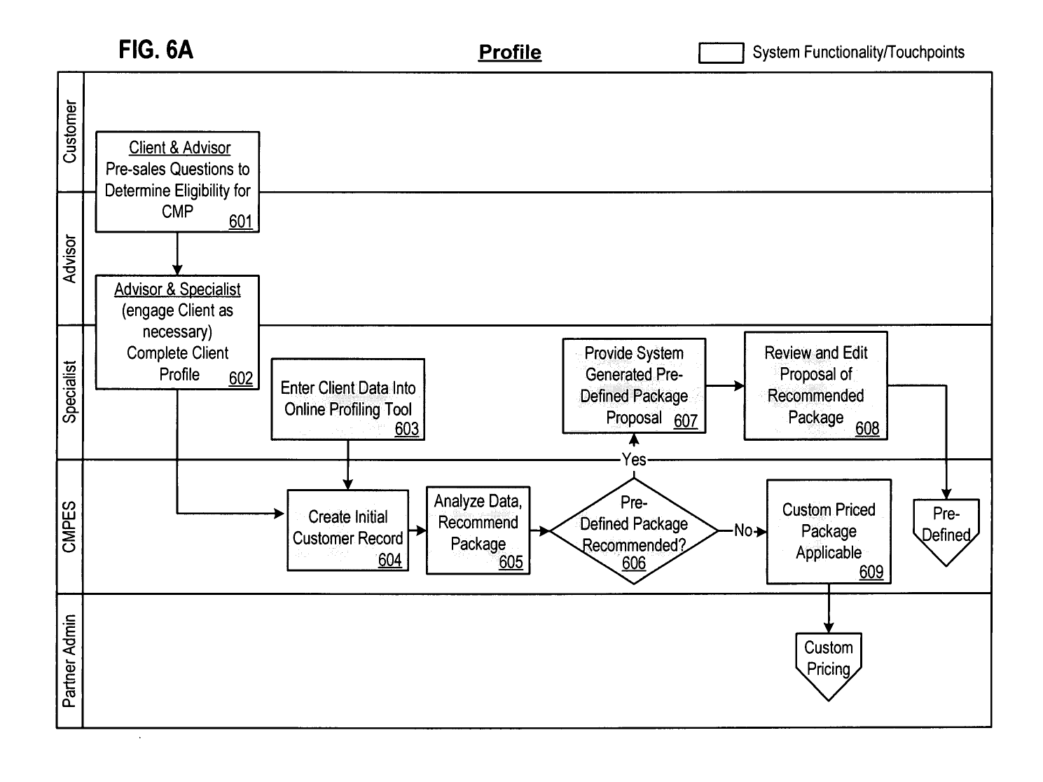

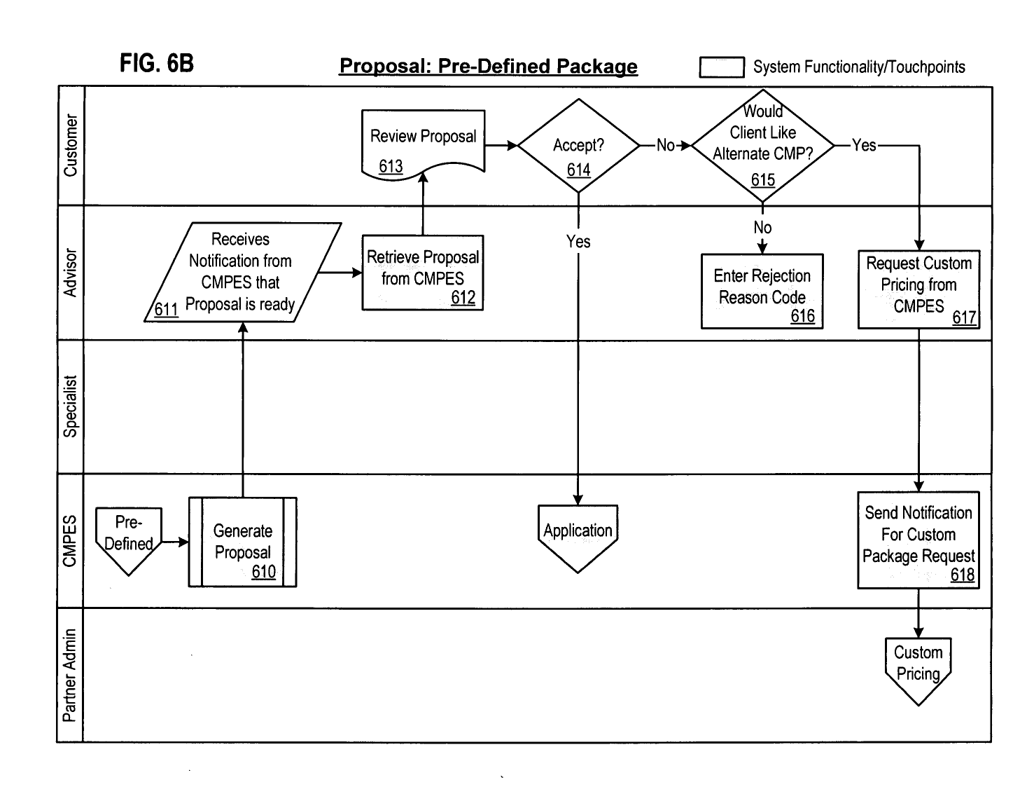

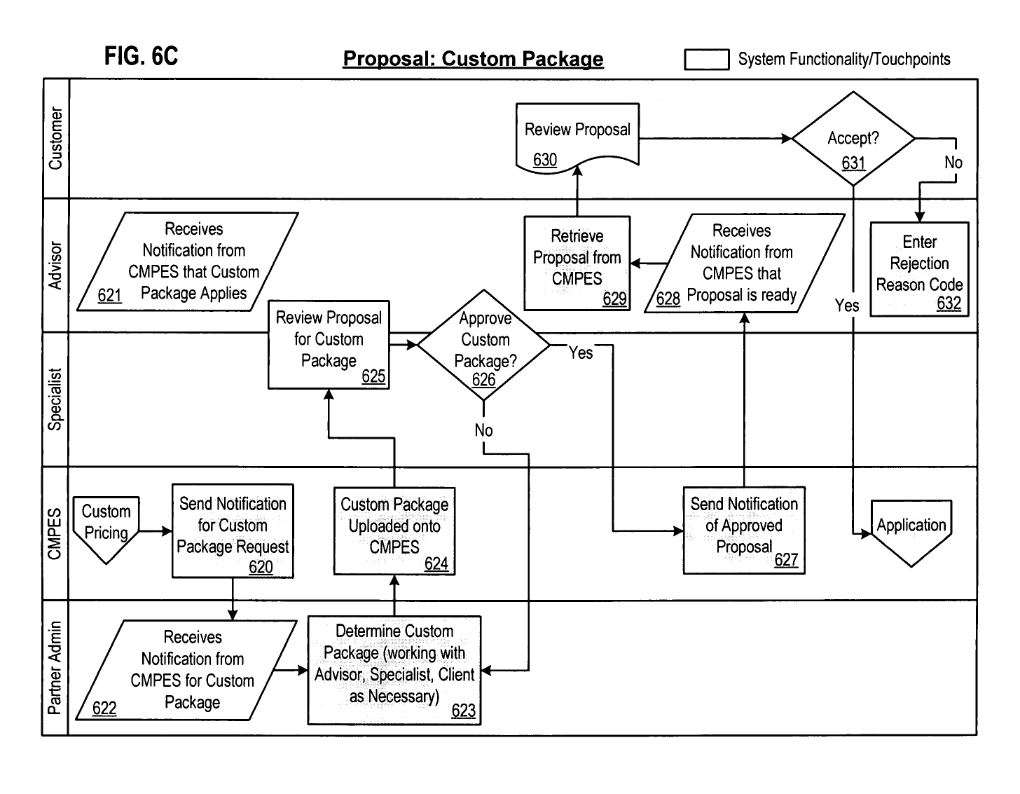

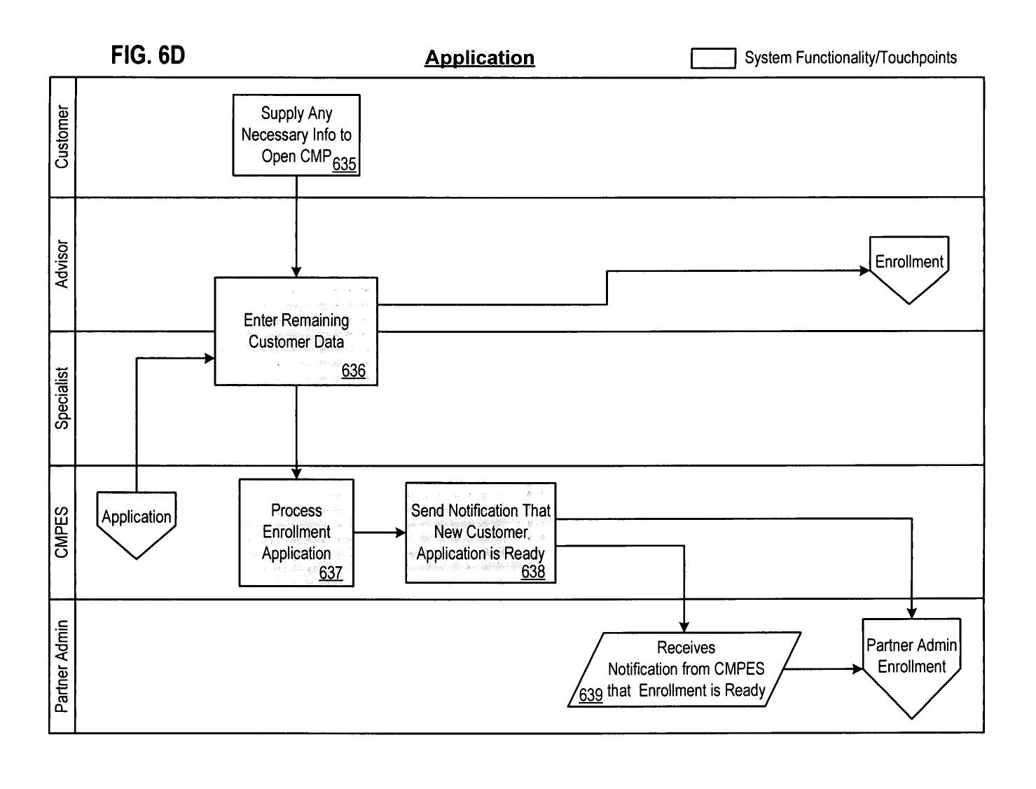

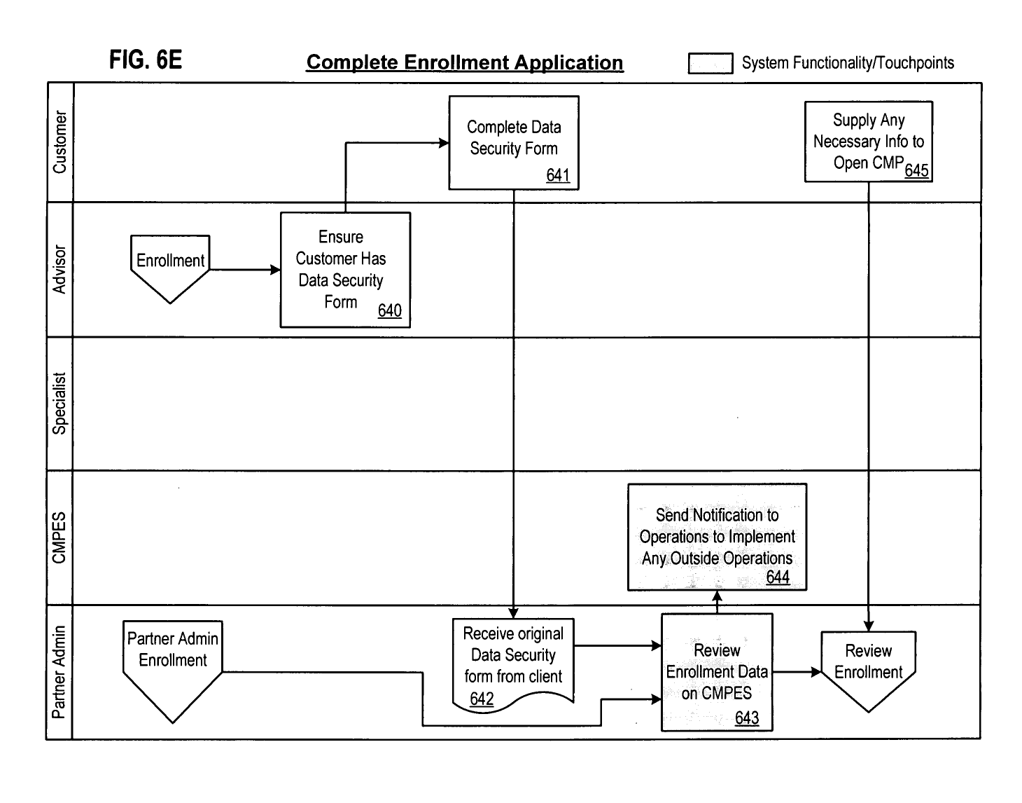

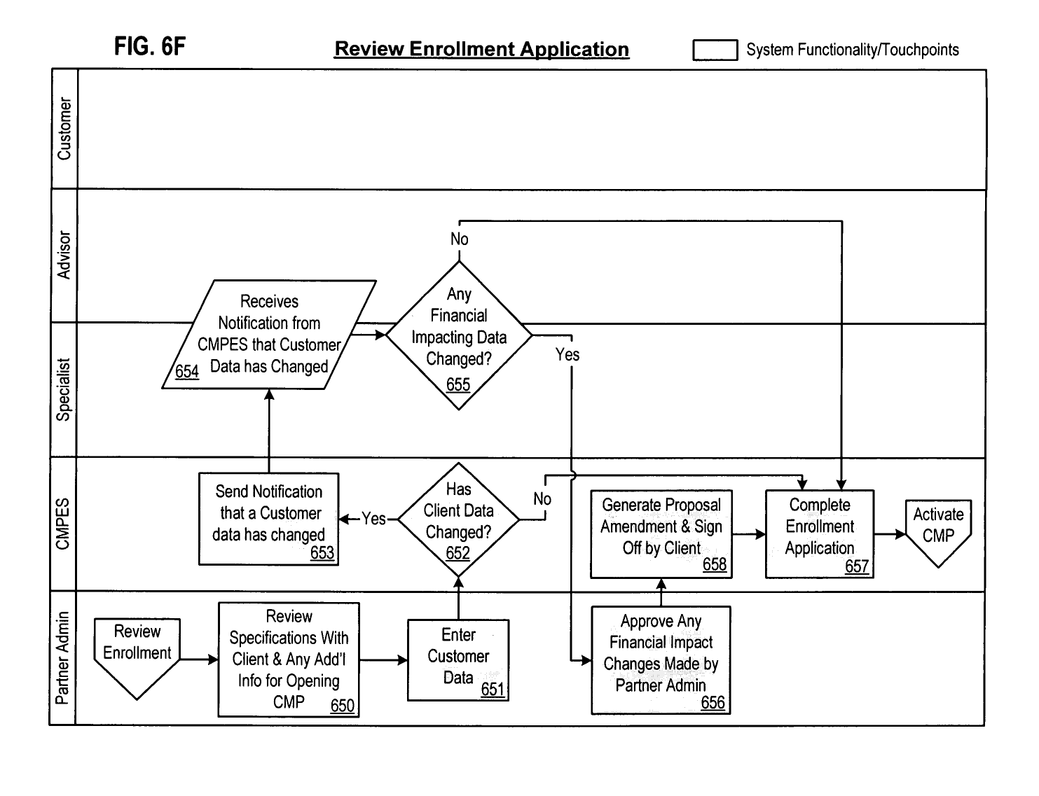

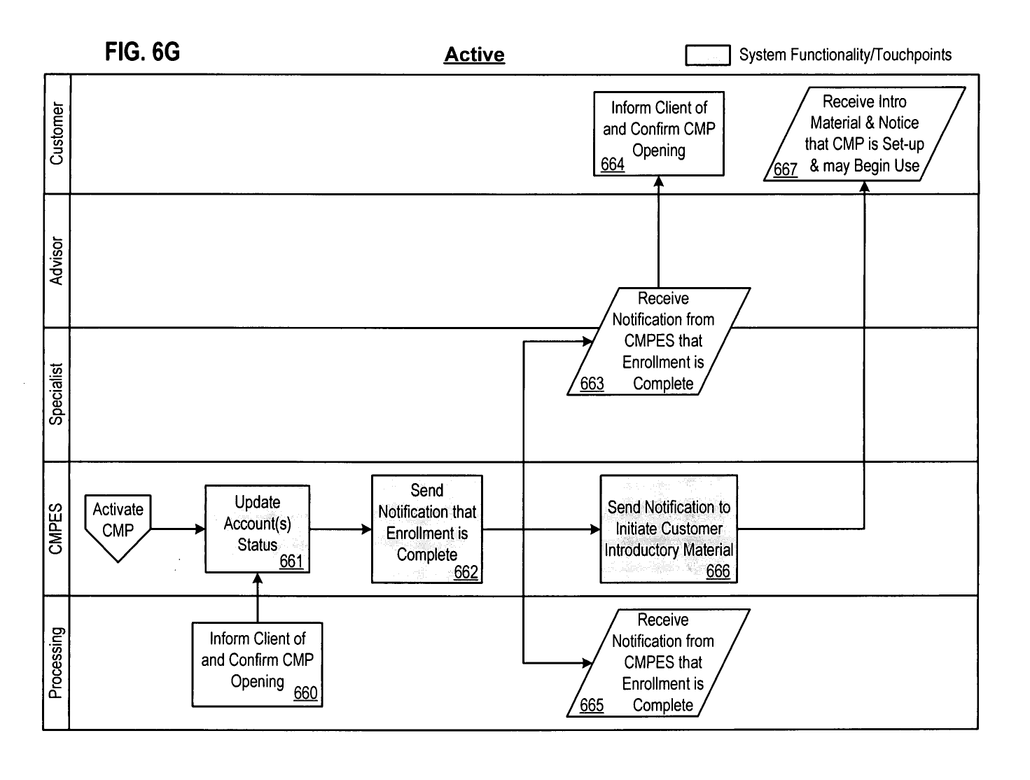

FIGS. 6A-G provide an illustration of embodiments of a CMPES. Although the system described in association with these figures is by no means the only way in which a CMPES may operate, this illustrative example aids in understanding the operation of a CMPES from the beginning to the end of an enrollment. This illustrative example separates the enrollment process into stages, which will each be discussed separately, along with the relevant discussion pertinent to that portion of the CMPES, to ease understanding of the invention. To further aid in the illustration of this embodiment, steps which may be implemented using or in conjunction with the system are shaded. Exactly which steps may be implemented using or in conjunction with the system will depend upon the application of the system and/or specifications for the system. In this illustration, a customer, advisor, specialist, and partner administrator are involved. The capital management product has been requested by the customer and a third-party partner administrator is involved to provide any custom capital management product proposal and administrative functions once the capital management product is created. This illustration also describes how two internal parties may function together and interact with the system during an enrollment; in this example an advisor and a specialist. In this example, certain steps are taken by the advisor and others by the specialist, while other steps may be taken by either party or both parties. Both parties are considered users of the system. These steps may alternatively all be taken by one party, as opposed to split between the two as described below. Additional parties are described in this embodiment to illustrate the flexibility of CMPES.

### Illustrative Example: Profile

FIG. 6A provides an illustrative example of the profiling steps of a CMPES. This example starts with a consultation between an advisor and a customer 601. During this consultation, the customer may outline their needs and information relevant to their needs and capital management product. The advisor may ask a series of pre-sales questions to assist in this effort. This consultation should serve to determine whether the customer is indeed eligible for a capital management product and, possibly, whether a capital management product will meet the needs of the customer. If the customer is indeed eligible for a capital management product, the advisor and/or specialist may take additional measures to complete the customer's profile 602. This may entail providing additional information about the customer and/or relevant circumstances beyond what was originally provided during the first consultation with the customer.

Information about the customer may then be entered into the CMPES by the specialist through a profiling utility within the systm 603. Using this data, the system will create an initial customer record 604, analyze the data, as discussed above, and recommend a package based on the parameters established in the CMPES and the relevant circumstances of the customer 605. The customer's data may be maintained in confidence and using typical data security measures. If the system selects a previously defined package 606, it may communicate the selection of this previously-defined, system generated package and provide a proposal to the specialist outlining the package selected 607. The specialist may then review and modify (if it so chooses) the system pre-defined package 608 on the system and proceed to steps for generating a pre-defined proposal, discussed below and illustrated on FIG. 6B. If the system does not select a previously defined package 606, a custom-priced package may be designed to meet the needs of the client 609. The system may communicate this result to the user (advisor and/or specialist), displaying a message that a custom priced package is recommended for this client. The system may then proceed to the steps for generating a custom proposal, discussed below and illustrated in FIG. 6C.

### Proposal

Depending on the product selected, a pre-defined package or custom proposal may be necessary. The pre-defined package proposal is created and maintained within the CMPES. Pricing for the pre-defined package proposal may be calculated by the CMPES and automatically included in the proposal. When the proposal is complete, the user can download the proposal in computer readable and/or printable format (e.g. PDF, DOC, WPD, JPG, GIF, etc.).

The custom proposal may be created internally or by a third party (e.g. the partner administrator). This proposal may also be prepared in a computer readable and/or printable format. This proposal may then be uploaded into the CMPES when sufficiently complete. In addition, the partner administrator may optionally create and upload a separate document containing the custom price details of the proposal. When the custom proposal is complete, the user can download the proposal and pricing sheet (optionally, as separate documents).

In addition, the user can also associate supporting documents to pre-defined and custom proposals, or include pre-approved product content in pre-defined proposals. The supporting documents may be accessible through the CMPES and may or may not be generated as part of the proposal. In the case of a customer, the user may choose not to show all content to the customer and may select which content to provide to the customer. Certain product content may be pre-approved for view by the customer and may be added to the main proposal. The CMPES may provide the ability to open the documents on the system and/or, optionally, access to such documents. The documents may be viewed and/or printed by the user. Optionally, a user may edit one or more of the documents existing on and provided by the CMPES. The user may select from pre-approved marketing documents to associate to the proposal. These documents may be maintained through a system administration function and may be stored in system memory or provided by an outside computer system and accessed through a communications network. The user may also be provided the ability to upload documents onto the CMPES and may optionally be associated with one or more proposals.

In one embodiment, the CMPES provides a user interface for a customer separate and apart from the user interface provided to the user of the system. This additional customer user interface may provide pre-filtered information to the customer, including any proposal, pricing, content, and/or the like, pre-approved or otherwise depending upon the design of the system. This additional interface provides greater flexibility in that a customer may gain access at any time to content specifically intended for the customer to view and the customer may be shielded from content not intended to be reviewed by the customer. This additional user interface may be provided in various ways, including via a computer system, a communications network, including the Internet, and/or the like. For example, this customer user interface may be provided on the Web. The content intended for the customer may be translated to a language compatible with the Web, allowing the user to view the content using a web browser on the customer's computer system, optionally by logging onto a system for security and identification.

### Pre-Defined Package Proposal

The CMPES may generate a proposal automatically or the user may use the CMPES to generate a proposal relying on data and outputs provided by the CMPES. In one embodiment, a proposal is made up of the four (4) different types of sections: (1) Required, non-editable sections; (2) Required, editable sections; (3) Optional, non-editable sections; and (4) Optional, editable sections. The required sections may be automatically added when the proposal is created. In addition, the user can modify the content of any editable sections.

The order of sections in the proposal may be pre-established to create a standard format for the proposals. When the user completes the review and editing of the proposal, the user may finalize the proposal using the CMPES or externally and upload it to the CMPES. A pre-defined package may be amended after it is completed. Such an amendment may be made in any fashion that records the change to the proposal. Commonly, the amendment may be a separate item, distinct from but associated to the proposal or a modification to the proposal where the modification is highlighted or recorded in some fashion. This serves to highlight that the proposal as originally generated has been modified and what the modification is.

A computer-readable version proposal will then be created using one or more of the proposal sections, pricing proforma, data security form, and/or the like. This proposal may be saved in memory within the CMPES and may be associated with one or more customers. In one embodiment, this proposal may be generated such that no alterations may be made to its contents.

### Illustrative Example: Pre-Defined Package Proposal

FIG. 6B provides an illustrative example of the proposal steps of a CMPES for a pre-defined package proposal. When the system has recommended a pre-defined package proposal, it may generate a proposal outlining some or all of the details of the pre-defined package 610. The user may then be notified that a proposal is ready 611. The proposal, once generated, may be retrieved by a user from the CMPES 612. The advisor, in this case, receives notification from the CMPES that the proposal is ready, allowing the advisor to retrieve the proposal from CMPES 612. The proposal is then reviewed by the customer 613. If the customer decides to accept 614, the application process begins, which is discussed below and illustrated in FIG. 6D. If the customer decides not to accept 614, the customer is presented with the option to be provided with an alternate capital management product proposal 615. If the customer chooses not to receive an alternate capital management product proposal, the advisor may enter a reason for the rejection into the system 616. Certain standard rejections may be provided to and selected by the user, as well as an open format option for providing a specific rejection which may not be listed. If the customer indeed accepts the offer to review an alternate capital management product proposal 615, the CMPES may provide the advisor the ability to request a custom priced capital management product proposal 617. Once a request has been made to the CMPES for a custom package proposal, the system may send a notification for a custom package request to interested parties 618. This would lead to the custom package proposal process, which is discussed below and illustrated in FIG. 6C.

### Custom Proposal

If the profile analysis determines that a custom priced package is appropriate for the client, the CMPES will communicate this to the user. Additionally, the system may communicate this to multiple interested parties. If a partner administrator is involved in the enrollment process, an actionable notification may be communicated from the CMPES to the partner administrator indicating that there has been a request for custom proposal and pricing. These notifications may provide links for the recipient to access the CMPES to access the customer information associated with the custom package request. The partner administrator may prepare a custom proposal using the CMPES or generate the proposal external to the system and load it on to the system for use within the CMPES, based on the data and circumstances provided for analysis.

After completing the administrator's portions of the proposal, the administrator may save the proposal in memory with the CMPES or upload the proposal to the CMPES and save it in memory. If appropriate, the user (e.g. advisor, specialist, etc.) may enter additional information into or as an addendum to the proposal on the CMPES. A custom package may also be amended after it is completed. The amendment may be similarly maintained separately from, but attached to the proposal or may modify the existing proposal. The CMPES may associate the proposal and any amendments or addendums to the request for a custom proposal, customer account, and/or customer information in memory. In one embodiment, the documents loaded onto the system are not in an initially editable form.

If the user approves of the custom package, an actual custom package proposal may be generated for the customer by or using the CMPES. In one embodiment, multiple approvals may be involved prior to the generation of a customer proposal. For example, if a specialist is involved in the enrollment, he or she may review and/or approve or disapprove of the custom package proposal. This proposal may be approved using the CMPES or external to the CMPES and recorded within the system.

If changes to the proposal are preferred, the party generating the custom proposal (e.g., a partner administrator) may be contacted, using the CMPES or otherwise, to discuss the preferred changes. Once amended, the proposal may again be uploaded and/or saved to memory as a new proposal. This step is implemented to provide the user additional means of control over the operation of the system. This is especially useful when a partner administrator is generating the custom package proposal.

Once a proposal has been generated for the customer, the CMPES may send a notification to one or more users that the proposal is ready for the customer to review. In one embodiment, this notification may be actionable, allowing the user to access the customer proposal using the notification. The proposal may then be delivered to the customer in hard or soft copy in a form which is initially not editable.

The customer may then review the proposal and decide whether they would like to implement the capital management product proposed. If the customer accepts the proposal, the advisor may deliver a data security form for the customer to complete, sign, and deliver to the necessary party(s). The CMPES may provide the user, or possibly the customer, the functionality to log in to the system and accept the proposal. Once the customer has accepted the proposal, the CMPES may begin the application steps of the enrollment process.

If the customer does not accept the proposal, the user may provide an indication on the CMPES that the proposal was rejected and, in one embodiment, the reason for the rejection. Optionally, this reason may be communicated to the party generating the custom package proposal. In one embodiment, the customer may be presented with and choose from a number of standard reasons for rejecting a proposal. Alternatively, or in addition, the customer may present a reason for rejection that does not meet within the standard reasons. These reasons for rejection may be saved in memory on the CMPES and associated with one or more of the customer, partner administrator, advisor, specialist, proposal, and/or like. The custom proposal may then be designated in some form within the CMPES as rejected.

The customer may also be presented with options after rejecting the custom package proposal. One such option may be to initiate another capital management product proposal. The CMPES may be implemented to generate a second capital management product proposal (pre-defined or custom). In one embodiment, the customer may provide additional information, possibly including the reason(s) for rejecting the first proposal. This additional information may be used in generating a second proposal. Further, one or more users may take a more active roll in the enrollment process using the CMPES to ensure that the second proposal more accurately fits the needs and/or desires of the client.

The user may indicate on the CMPES that the first proposal has been rejected and that the client has further interest in a capital management product proposal. The user may then initiate the generation of another proposal using the system. In some aspects, at this point, the proposal stage is restarted for this request but with additional information.

### Illustrative Example: Custom Package Proposal

FIG. 6C provides an illustrative example of the proposal steps of a CMPES for a custom package proposal. When the system has recommended a custom package proposal, it may notify the advisor, in this example, that a custom package is appropriate given the circumstances and CMPES parameters 621. If a partner administrator is to used, the CMPES may contact the administrator to request a custom package be generated 622. The system may also provide the partner administrator with sufficient information to generate a custom package. The partner administrator may then construct a custom package in an attempt to meet the customer's circumstances, needs, and/or desires 623. A custom package may include the basic structure of one or more capital management products, the pricing data of the capital management product(s), the optional services, the volume estimates, and/or the like. In generating this customized capital management product package, the partner administrator may communicate and/or work in conjunction with the advisor, specialist, and/or customer associated with the custom capital management product package requested.

As an example, in one embodiment, the partner administrator may receive an e-mail notification from the CMPES that a custom package has been requested based on the system's analysis of a customer's circumstances. This e-mail may provide information or provide access to information on CMPES sufficient for the partner administrator to construct a custom package. If the information provided by CMPES is insufficient, the partner administrator may contact one or more of the associated advisor, specialist, and/or customer. Alternatively, the partner administrator may be able to utilize CMPES to obtain additional information. As discussed above, CMPES may provide specific access to different users, allowing certain users defined access to specific data on the system. Using this structure, the partner administrator may log onto the system and gain access to additional data to assist in constructing a custom capital management product package.

Once the partner administrator has constructed a custom capital management product package, the proposed package may be loaded onto CMPES 624. The system may notify the advisor and/or specialist that a custom package has been created and loaded onto the CMPES. The advisor and/or specialist may review the custom proposal 625 and, if they approve of the custom package 626, the CMPES may notify the advisor and/or specialist to retrieve the proposal and custom package pricing to present to the client 627. If the advisor and/or specialist do not approve of one or more aspects of the custom package 626, the partner administrator may be contacted and provided the opportunity to create another custom package. Additional information or requirements may be provided to allow the partner administrator the ability to construct a custom package that meet the advisor's and/or specialist's standards or requirements. If the first custom package is not approved, the partner administrator may construct a second custom package 623 and load the new custom package onto CMPES 624. The advisor and/or specialist may then review this second custom proposal 625. If approved, the CMPES may then notify the advisor and/or specialist to retrieve the proposal and custom package pricing to present to the client 627. If not approved, the partner administrator may be given another opportunity or the advisor and/or specialist may decide to contact another partner administrator or end the enrollment process.

Once the proposal is generated, the CMPES may notify the advisor that it is ready 628 and the advisor may access the proposal and retrieve it from CMPES 629. The advisor may then present the proposal and any additional content to the customer 630 for the customer to decide whether to enroll in the proposed capital management product. If the customer accepts the proposal 631, the application stage of the enrollment process may begin. If the customer does not accept the proposal 631, one or more rejection codes may be entered into the CMPES 632. In one embodiment (not illustrated here), as discussed above, other steps may be taken if the customer rejects the proposal, such as initiating the generation of another package proposal, including one that takes into consideration certain considerations that were used in rejecting the first proposed package.

### Proposal Revision

As discussed above, proposals may be revised and/or supplemented. After a proposal has been generated and/or uploaded to the CMPES, but before the customer has provided a decision, the user can make changes to the client profile and optional services.

In one embodiment, changes may be categorized as financial impacting or non-financial impacting. Some existing data may be overwritten by the changed data and a history of changes will not be maintained within the system. However, a financial impacting change may cause a proposal revision process to begin. A change is considered financial impacting if one or more of the following fields are modified: the number of capital management products, the number of units processed, the total cost, changes to the optional services, changes to volume estimates, capital management products with differing optional services, whether to use OCR, industry, and/or the like. A non-financial impacting change would not require the system to execute a proposal revision process.

In one embodiment of a proposal revision process, the system may begin by executing the package selection process. A request that was previously a pre-defined package may become a custom solution and vice versa. If a financial impacting change is made and the proposed package is pre-defined, the existing proposal may be canceled by or using the CMPES. The CMPES will direct the user to the beginning of the proposal stage to make any necessary proposal changes. When finalized in the CMPES, the user may send the proposal to the client for a decision. If a financial impacting change is made and the proposal is a customized package, the existing proposal will be canceled by or using the CMPES. If a partner administrator is involved and generated the customized package, the CMPES may notify the partner administrator of the need for a new proposal and pricing data. In addition, the partner administrator may provide additional information for the custom package proposal. If a non-financial impacting change is made, the CMPES may provide the user with an option to make changes and stores the changes in memory. In any case, the changes will be saved in addition to or and overwrite the previous data. Such changes may be logged within the CMPES. The system may also provide an indication (e.g. through access restriction to canceled proposals, warning notifications, highlighting, and/or the like) to the user to use the revised proposal instead of the original (canceled) proposal.

### Application

If the customer has accepted the capital management product proposal, a user may access the CMPES to enter additional data sufficient to proceed with the enrollment of the customer into the accepted capital management product. Alternatively, the customer may be given access to the CMPES to enter such additional information into the system. As discussed above, the customer may be provided with specific log in information (e.g. log in I.D. and password) that will provide a customized view of the CMPES for the customer and restricted access rights to data and/or functions in the system. In one embodiment, access to the CMPES and/or any data or components within the system may be restricted during the application process to prevent the corruption of any data or interference in the application stage of the process.

A user may provide client identifiers (e.g. client account numbers, names, proposal identification numbers, etc.) to retrieve the proper customer information and proposal associated with the customer. This will provide at least some of the information that will be used in the customer's capital management product application. The CMPES may pre-fill information where possible in a situation where the information has been entered or saved on the system elsewhere.

If certain data conflicts with other data or any aspects of the customer's account or proposal conflicts, the CMPES may present an error message to the user that such a conflict exists. Additionally, if the user does not have permission by the system to access certain data or initiate requested functions of the CMPES, the system may also present an error message that the user does not have the proper permission to access such data or initiate such functions of the system. These access restrictions may be based on one or more of a number of circumstances, including account parameters, proposal parameters, the user, the user's supervisor, the customer, and/or the like. Such restrictions may also be created within the CMPES to prevent certain users from certain data and/or functions within the system.

If the customer has chosen to set up multiple and/or different capital management products, the details would be entered into the CMPES about the multiple capital management products. The system may pre-fill information for each separate capital management product based on information from one capital management product. A user may override this pre-filled information in case of error, differences, or otherwise.

In one embodiment, upon finalizing an application, if a financial impacting change has been made, the previous and current data will be stored in the system. The user performing the change will be required to confirm the financial impacting changes. The user may communicate with the administrator or any party involved in generating the proposal or administering the capital management product to confirm that the changes are acceptable. Once the financial impacting change is agreed upon, an amendment may be generated using the system. This amendment may be communicated to one or more interested parties and one or more of these parties may be required to approve of the amendment before the application process continues.

Other changes (e.g. non-financial impacting changes) may be made in the system and the changes may be saved to the system and may overwrite the previous data. In one embodiment, a log of such changes, including possibly a register of the previous changed data, may be maintained in the system.

When the application is finalized, the interested parties, including a partner administrator if one is associated with the capital management product, are notified that an application is ready for review. One or more of these parties may be given the opportunity to confirm the data and/or capital management product details prior to enrolling the customer into the capital management product. For example, a partner administrator may be asked to confirm the customer details and structure and details of the proposed capital management product prior to initiating the enrollment of the customer into the capital management product. If any changes are suggested, an amendment process as described above (financial impacting or non-financial impacting) may be used to implement the changes. If no changes are recommended, the application may be ready for enrollment.

### Proposal Amendment After Customer Acceptance

In one embodiment, when a financial impacting change is made to a proposal that has already been accepted by a customer, an amendment is necessary. These changes may be made or suggested by one or more of the parties associated with the CMPES. An amendment document is a document showing the previous and updated values. When saving financial impacting changes on the system, the current values will not be overwritten with the updated values. Both versions may be maintained in the system. It is possible that through the financial impacting change, the originally selected package is no longer valid. The system may execute the package selection process as discussed above again.

Typically, the changes made must be confirmed by one or more of the parties associated with the customer and/or proposal. The CMPES may communicate to each of the parties that are required to confirm such a change, that a change has been proposed and that they must approve the change before the application may proceed. The user may then be presented with a side-by-side comparison of the financial impacting fields that were modified with the previous and updated values displayed. If the user rejects the amendment, the change may be cancelled and the request will revert to the previous values. If one user rejects an amendment and the previous values are reverted to, the system may require one or more parties involved to confirm the use of the previous values. Alternatively or in addition, the user rejecting the amendment may propose suggestions for amending the values. These parties may communicate within or outside of the system to reach values that are agreed upon by all parties involved.

If a custom solution has been prepared for and approved by the customer and the amendment has been confirmed, the system may generate an amendment document. If necessary, a partner administrator may be asked to provide an updated custom pricing sheet. The partner administrator may then generate this document and upload it to the CMPES.

If a pre-defined package was prepared for and approved by the customer and the amendment has been confirmed, the system may automatically generate an amendment document and update the pricing.

The user may download the amendment document and deliver it to the customer for acceptance. If the customer accepts the amendment, the updated values will be saved on the CMPES replacing the previous values. If the customer rejects the amendment, the change will be cancelled, updated values will be discarded, and the request on the CMPES will revert to the previous values accepted by the customer.

In one embodiment, while an outstanding amendment is awaiting a customer's decision, the request may not be modified or proceed through another amendment and the enrollment process may not continue. If the customer requires changes, the amendment should be rejected. The user may implement CMPES to make any changes requested by the customer. In some cases one or more of the other parties involved may have to approve these changes.

### Illustrative Example: Application

FIG. 6D provides an illustrative example of the application steps of a CMPES. When a proposed capital management product package (pre-defined or custom) has been approved by the customer, this approval may be entered into the CMPES indicating that the system may continue into the application stage of the enrollment process. At this point, the advisor and/or specialist may enter additional information into the system about the customer and/or capital management product 636. As necessary, the customer may supply any necessary or desired information 635. Typically, but not necessarily, the advisor and/or specialist will enter whatever information is sufficient to enroll the customer into the selected capital management product. Once this remaining data is entered into CMPES, the application is ready for enrollment. It is of course possible that no additional data need be entered at this time and the application is ready for enrollment without further modification. The CMPES may then notify one or more of the parties associated with the application (e.g. the partner administrator) to confirm or make changes to the enrollment application and process the enrollment application 637. Exactly how the application is processed and what the results of such processing will depend upon how the CMPES is constructed and the considerations for implementing the CMPES, the proposal, the customer, and/or the like. In certain embodiments, this processing may entail providing certain parties with relevant information, initiating the proper enrollment procedures, seeking additional authorization, communicating the enrollment of the customer in the capital management product to a system maintaining records for the customer, communicating to other parties that may be impacted by the enrollment, and/or the like. Alternatively, one or more steps of this processing may be taken by persons and/or systems outside of the CMPES, such as but not limited to a partner administrator or partner bank.

Once the application has been processed by the system, the system may send a communication to one or more of the interested parties that a new customer application is ready 638. In this example, the partner administrator receives notification that the customer and customer application are ready to be reviewed for enrollment in the capital management product 639. At this point, the partner administrator may begin their own enrollment process for the customer and intended capital management product.

### Complete Enrollment and Activation

When a proposal has been accepted and the application completed, the enrollment stage begins. This is the stage where the capital management product is actually constructed for the customer's use.

If a partner administrator is involved, the administrator may receive notification that the capital management product application is ready for enrollment, as in the example above. Once this notification is received, the partner administrator may begin the enrollment steps through the CMPES. As a user to the system, the partner administrator may log into the system in order to initiate and complete steps of the enrollment process. During this process, the partner administrator may enter capital management product implementation information into the system. This information may allow the capital management product to function once activated and/or may provide the necessary information with which the capital management product may operate. The partner administrator may also enter data about themselves, which may be used in the activation of or during the operation of the capital management product. For example, the partner administrator may enter account information, routing numbers, contact information, information about related entities or systems, data protocols, system addresses, hardware descriptions, and/or the like. The user may complete this in various steps, entering portions of data at a time, if preferred. The CMPES provides the ability for a user to save their work and continue the work at a later point.

After the partner administrator has completed their portion of the enrollment, if there are one or more operations groups and/or systems involved, these groups and/or systems may then be notified of the enrollment of the customer into a capital management product. The CMPES may provide an interface for one or more of the operations groups and/or systems to access the CMPES and/or data on the CMPES. This access may be limited as discussed above using log in identification. If these operations groups and/or systems are involved, they may be required to complete certain tasks outside of the CMPES as a part of the enrollment process. The system may provide them with a list of outstanding capital management product requests waiting to be processed and/or outstanding tasks to be processed associated with the capital management products. If tasks are required of one or more of the operations groups and/or systems for the enrollment to continue, the system may prevent the capital management product from becoming active until such tasks are completed.

### Illustrative Example: Complete Enrollment, Review and Activation

FIG. 6E provides an illustrative example of the steps for completing an enrollment application of a CMPES embodiment. When the customer has accepted a proposed capital management product and an application for this customer has been completed, the customer may be given forms to complete or contracts to sign and/or the like. One example of this, as used herein, might be a data security form. It is to be understood that other types of paperwork may be used in a similar manner. The advisor, in this embodiment, will ensure that the customer has received and completed this data security form 640. The customer can complete this form 641 and send it to the appropriate parties. In this case, the partner administrator may take the data security form from the client 642. Once the partner administrator has received notice from the CMPES that enrollment is ready 638 and the data security form from the client 642, they may review the enrollment data on CMPES 643. The enrollment application may be reviewed by one or more parties to verify that the data entered and package specifications are correct. Alternatively, the system may perform such verifications. If one or more operations units exists, which may manage certain procedures in the implementation and/or operation of the CMP, once the enrollment application has been completed, this (these) operations unit(s) may be notified of the completion of the enrollment application 644. At this point, the operation unit(s) may implement their activities as associated with the enrollment application and/or CMP. As necessary, the customer may provide additional information to facilitate the opening and/or operation of the capital management product 645.

FIG. 6F provides an illustrative example of the enrollment application review process. It is of course understood that a review process may be implemented at any step, or at multiple steps, during an application and/or enrollment process. After reviewing the data independently, the partner administrator may review the specifications of the capital management product in which the customer will be enrolling with the customer and requesting any additional data desired for opening the capital management product 650. Once sufficient data has been retrieved from the system and/or customer, the partner administrator may access the CMPES and enter additional data into the system 651. In one embodiment, the partner administrator may access an enrollment interface on the CMPES, which would be specifically created for use in enrolling a customer into a capital management product. The system may verify if the customer's data has changed or if any errors appear in the data 652. If the data is consistent and/or no errors exist, the system may be notified/authorized to complete the enrollment application for the capital management product 657. Whether changes exist may also be determined outside of the system. Once the capital management product enrollment is complete, the capital management product may be activated for the customer's use. If the data has changed and/or the system detects errors in the data, the system may send a notification to the advisor and/or specialist that the data has changed or is in error 653. The advisor and/or specialist receive(s) this notification from the CMPES 654 and may review to see if any changes have impacted the financial data 655. If the changes have not impacted any financial data, the advisor and/or specialist may indicate this to the system and authorize it to complete the enrollment application for the capital management product 657. If financial data has been impacted by the changes, the partner administrator must approve of the changes 656. Alternatively, in one embodiment, approval of certain changes may be required by other parties associated with the enrollment, such as the advisor and/or specialist in this example. If the changes are approved, the CMPES may then generate a proposal amendment, as discussed above, and have the customer review the amendment, agree to it, and sign it 658. If the customer has agreed to the changes and proposal amendment 658, the advisor and/or specialist may indicate this to the system and authorize it to complete the enrollment application for the capital management product 657.

FIG. 6G provides an illustrative example of the initial activation of a capital management product once enrollment is completed. If one or more operations groups are involved in the application and/or enrollment process as discussed above, these operations groups may conduct their activities outside of the system 660. If there is any input into the system based on these activities, it may be input into the system as and where appropriate. If there are activities taken by one or more of these operations groups, these activities should be complete prior to activating the capital management product.

Where applicable, the CMPES may update one or more of the accounts, records, files, accounts, and/or the like impacted by the activation 661 and send notification to one or more of the parties involved in the enrollment process that the enrollment process is complete 662. The advisor and/or specialist may receive notification from the system that the enrollment process is complete 663, inform the client of its completion and confirm the opening of the capital management product 664. The partner administrator, if necessary, may also receive notification of the completion of the enrollment process 665. In one embodiment, the CMPES may designate the capital management product as complete. The system may also send a communication to another system and/or person to initiate the preparation of customer introductory materials and initiate the process for sending the customer the proper introductory materials 666. For example, after the operations units have completed their review, the CMPES could send a system message to a fulfillment system to prepare and mail introductory materials, such as a customer welcome kit, to the customer enrolling in the capital management product. Once the customer has received their materials and notice that the capital management product is set up and ready for use, the customer may begin using the capital management product 667.

### CMPES Operational Functionality

The CMPES provides a flexible foundation with which a user may accomplish tasks associated with enrolling a customer into the proper capital management product. In order to provide this flexibility, a CMPES is comprised of a number of components, which each provide a flexible means for accomplishing specific tasks during the enrollment process. One area in which the CMPES provides such flexibility is in its ability to function with multiple users and provide each different type of user with the functions, communications, data, and/or the like to accomplish any relevant tasks. This system provides a centralized system with inputs from multiple sources. Each party involved in proposing a capital management product to a customer and/or enrolling the customer into a capital management product may be provided with access to the CMPES and the CMPES may serve each user in their individual capacities. The term “user” may be used generically herein as any party accessing the CMPES and may refer to one or more of the related parties discussed herein employing or working in conjunction with the system.

In one embodiment each type of user may be provided with a custom-tailored interface or dashboard. This dashboard may be customized or personalized for and/or by the user. For example, depending upon what party is accessing the system, a means for identifying this party to the system may be used and, upon recognition of this party, the system may provide a user interface that has been designed for that type of user, possibly providing convenient access to data and functions pertinent or relevant to the user's input and/or operation of the system. A user may be given a log-in identification number and/or name and a password for identification and security. Accounts may be created for each user of the system and/or each role associated with the system and/or enrollment process.

In one embodiment, all users assigned to the CMPES must have permission to access the system and may have permission to access only certain functions and/or data within the system depending upon their permission level and role in the enrollment process. Moreover, these permission levels may dictate how much a user may modify data on the system or alter system components. At one end, for example, a system administrator may have a very high permission, which would allow for the modifying of code, system components, access permission levels, access restrictions, data, proforma, documents, and/or the like, whereas a customer may be provided simply with a view only access to limited data designated specifically for view by the customer. Through this system administrator function, users may be created, modified, and/or deactivated. A user account may consist of any of a variety of properties and functions as may be preferred for a particular CMPES embodiment.

The CMPES is aware of each user to the system and the relationships between and/or among the users and user types. The system may recognize which users are internal and which are external and/or what the relationship is between certain users and the users or persons they report to (e.g. team leaders, managers, supervisors, etc.). For example, in one embodiment, in order to support the custom proposal approval logic, the system must recognize the relationships between the internal users (e.g. advisor, specialist) and the external user (e.g. partner administrator, field specialist). Also, for example, in another embodiment, in order to allow a manager to view proposals only for their advisors, the system must be aware of the relationship between the managers and the advisors for which they are responsible. Through this user manager function, a system administrator may define and maintain these relationships.

A user may prepare proposals using the CMPES and may provide these proposals to customers. The user may be able to edit the content of the proposal and the proposal sections, including identifying the order of the sections within the proposal, the title of one or more sections, the content of one or more sections, and/or the like. In one embodiment, the system may have editable sections and non-editable sections provided to the user, which may prevent the user from tampering with or modifying certain data presented in those sections. A benefit of preventing some sections from being editable is that the data provided in those sections is more likely to reflect the data as it exists in the system and/or may have been analyzed or relied upon in other aspects of the enrollment process. A user may also indicate if a section is required or optional for the proposal. Alternatively or additionally, the system may indicate whether certain sections should be required for the proposal. Editing of the proposals and proposal sections may take place outside of the system or, alternatively, a CMPES may provide such functionality internally.

Separate sets of proposal sections may exist in memory with the CMPES for each pre-defined package type. It is not necessary that each pre-defined package type have pre-existing proposal materials in memory on the CMPES, but the system does provide the functionality to. Moreover, some pre-existing proposal sections may be used with multiple pre-defined capital management product packages.

In one embodiment, a list of marketing documents may be maintained within the CMPES. The system may comprise a function that provides a user with a list of available marketing documents, maintained internally or accessible outside of the system. Alternatively or in addition, the system may provide a search function to allow the user the ability to search for certain marketing documents. When assigned to a proposal, the proposal may automatically be associated with certain documents on the CMPES. In one embodiment, the proposal when presented to a user may provide a link or point to the associated documents.

For example, in one embodiment, when a proposal is assigned, the proposal will point to a document. If the document is modified (and the system is still able to identify the document on the system), the proposal will automatically point to the modified document. If a change to a document has been made that prevents the system from automatically identifying the amended document on the system, a system administration function is provided to correct this and associate the proposal(s) with the amended document(s)

In one embodiment, separate proformas may exist for each pre-defined package type. A user of the CMPES in this embodiment is able to maintain the unit cost associated with each proforma line item along with a short and long description. The ability to load or remove proforma line items within the system may be restricted through a system administration function. Changes to a structure of a pricing proforma may require a programmatic change.

For example, in one embodiment, the proforma used by the CMPES consists of a collection of price line items. When calculating a pre-defined package price, each line item will have a volume estimate and a unit cost. The line item cost is calculated by multiplying the volume estimate by the unit cost.

In one embodiment of a CMPES for a lockbox product, proforma line items may be used to establish and present the estimated volume for a lockbox product. Volume estimates are significant to the design and/or selection of a lockbox product, as well as the pricing for a lockbox. In one embodiment, proforma line items for volume estimates may be viewed as fitting within one of the following categories: mandatory, optional (volume editable), optional (volume not editable), optional (Custom), and incidental. Mandatory proforma line items are volume estimates based on the profile questions and may not be modified. Volume estimates for optional (volume editable) proforma line items are based on best practices, but can be modified. Volume estimates for optional (volume not editable) proforma line items are based on the profile questions and cannot be modified, but, unlike mandatory proforma line items, these items can be selected by the customer. For volume estimates that may not be estimated or calculated, optional (custom) proforma line items may be selected, but must be custom priced. Finally, some volume estimates may not be estimated or calculated because the customer will not be aware when they will occur. These may be considered incidental proforma line items.

In one embodiment, the CMPES provides communications capabilities, including messaging and notification capabilities. The CMPES must communicate with one or more of the parties associated with a capital management product request and/or enrollment. Various forms of communications may be used by or with a CMPES. The use of e-mail is one such form of communication. It should be understood that any logical form of communication may be used. Various messages may be generated throughout the capital management product request and enrollment process. The distribution of messages is based upon the notification definition. Copies of the notification may be delivered to the users. One type of message is an actionable notification message. This message may inform a user that certain actions or tasks must be completed and may, but not necessarily, provide the means with which the user may accomplish these tasks. Another type of message is simply an informational notification message, which may simply relay information and not require immediate action. In a message (e.g., an e-mail) may contain in its body a link to a specific page or location within the CMPES for the user to access certain data or functions of the system.

The CMPES may, in one embodiment, provide reports. The system may be setup to generate one or more reports based on previously established templates. A user interface or front-end screen may be provided to retrieve these reports. The system may provide users with the ability to use filter criteria for a pre-defined set of fields. Some views of the CMPES may function as a “report,” but are technically dashboard views of the data. The CMPES may provide a print functionality, which would allow a user the ability to print a screen or any documents for use or illustration outside of the system.

### CMPES Functionality

In one embodiment of the CMPES, a user authentication may be used to protect the security of the system and provide custom-designed user interface for the user or type of user accessing the system. A CMPES may be constructed such that all users of the system may be authenticated. The authentication may be performed internally, where computer code has been generated to produce system components that will authenticate a user, or serviced by a third-party application associated with the system, where the system will pass the user's information through to an external component that will determine if the user can access the system, establish how the user may access the system, and/or structure what the user may access within the system. Access to particular pages and/or functions may be limited to the permissions assigned to a user's role in the system. A user may have one or more roles in a system.

The CMPES may interface or communicate with one or more other systems, as outlined above, to provide even greater flexibility and functionality. Through this connectivity, the CMPES may receive inputs from and send instructions to other systems. For example, in one embodiment, if a customer closes their account with the CMPES operator, their capital management product may also need to be closed. In this case, the CMPES will receive a data feed from an outside system when an account is closed. In turn, the CMPES will indicate the accounts that require closure within the system. The CMPES may also send notification to a partner administrator or other third parties alerting them of the closure of the capital management product. When the steps for closing an account are complete, a user may finalize the closure within the CMPES. In another embodiment, this connectivity will allow for the retrieval of customer data from external systems for incorporation within the CMPES. Similarly, data within the CMPES may be communicated to external systems.

The CMPES facilitates a more efficient operation on data, including data associated with a customer, customer account, users, capital management products, and/or the like. In one embodiment, the system may facilitate the modification of multiple sets of data where each set requires a similar modification. For example, the system may facilitate the bulk transfer of customer accounts. When a bulk transfer of an account is required, the records of one or more capital management products may be impacted. The CMPES may be used to update one or more records with a new account number. In this example, the system may receive a data communication from an external system that a bulk transfer has been or is being executed. In response, the CMPES will update the capital management product record(s) associated and/or impacted by the bulk transfer of accounts. For each entry of the old account information, the record will be updated with the new account information. A log may optionally be maintained of such changes. If a partner administrator and/or operations group(s) is or are involved, they may be notified of a bulk customer account change.

A conversion program may be used within or in association with the CMPES. This conversion functionality may provide the ability to transfer data about customers, customer accounts, users, capital management products, and/or the like from existing systems and capital management products into the CMPES.

A CMPES and various embodiments of a CMPES have been described herein. It should be understood that the above description is only representative of illustrative embodiments. For the convenience of the reader, the above descriptions have focused on a representative sample of all possible embodiments, a sample that teaches the principles of the system. The description has not attempted to exhaustively enumerate all possible variations. That alternate embodiments may not have been presented for a specific portion of the system or that further undescribed alternate embodiments may be available for a portion is not to be considered a disclaimer of those alternate embodiments. It will be appreciated that many of those undescribed embodiments incorporate the same principles of the system and others are equivalent. Those skilled in the art will recognize that the method and apparatus of the present system has many applications, and that the present system is not limited to the representative examples disclosed herein. Thus, it is to be understood that the embodiments and variations shown and described herein are merely illustrative of the principles of this system and that various modifications and variations may be implemented without departing from the scope and spirit of the system.

What is claimed is:

1. A processor-implemented method for facilitating an enrollment into a capital management product, comprising:
receiving data comprising one or more factors associated with a capital management product or party to be enrolled in a capital management product;
processing said data, employing computer logic to determine whether to recommend a capital management product comprising one or more of a previously-defined capital management product or a custom-designed capital management product; and
generating a proposal with pricing for the recommended capital management product.

2. The method of claim 1 further comprising:
processing application data for the recommended capital management product package.

3. The method of claim 1 wherein the capital management product comprises one or more of a lockbox product, zero-balance account, delayed disbursement, remote deposit or electronic data exchange.

4. The method of claim 1 further comprising:
processing said data to determine which previously-defined capital management product to recommend when a previously-defined capital management product is recommended.

5. The method of claim 4 further comprising:
generating one or more parameters of the recommended previously-defined capital management product.

6. The method of claim 5 further comprising:
customizing one or more parameters of the recommended previously-defined capital management product to meet one or more factors associated with a party to be enrolled in a capital management product.

7. The method of claim 1 further comprising:
transmitting a system message requesting that a capital management product be designed to meet one or more factors associated with a capital management product or party to be enrolled in a capital management product when a custom-designed capital management product is recommended.

8. The method of claim 1 further comprising:
requesting another capital management product be designed to meet the one or more factors associated with a capital management product or party to be enrolled in a capital management product when the proposal with pricing for a recommended capital management product is not accepted.

9. The method of claim 8 further comprising:
maintaining a record of at least a reason for a recommended capital management product not being accepted.

10. The method of claim 1 further comprising:
altering one or more previously-defined capital management products.

11. The method of claim 4 further comprising:
storing data concerning at least a specification of a previously-defined capital management product in accessible memory.

12. The method of claim 7 further comprising:
storing data concerning at least a specification of a custom-designed capital management product in accessible memory.

13. The method of claim 1 further comprising:
transmitting a communication to at least an internal party associated with an enrollment; and
transmitting a communication to at least an external party associated with an enrollment.

14. The method of claim 1 further comprising:
transmitting a communication to at least a computer system associated with an enrollment.

15. The method of claim 1 further comprising:
facilitating an amendment of the proposal for the recommended package.

16. The method of claim 1 further comprising:
facilitating an amendment of at least a specification of the recommended package.

17. The method of claim 16 further comprising:
requesting approval for an amendment that will impact financial considerations before making said amendment.

18. The method of claim 1 further comprising:
transmitting data to facilitate in creating a capital management product.

19. The method of claim 7 further comprising:
transmitting data to facilitate in designing a capital management product.

20. The method of claim 18 further comprising:
customizing the capital management product to meet one or more factors associated with a capital management product or party to be enrolled in a capital management product.

21. The method of claim 1 further comprising:
receiving inputs from one or more entities associated with an enrollment into a capital management product.

22. The method of claim 1 further comprising:
transmitting system messages to one or more entities associated with an enrollment into a capital management product.

23. The method of claim 1 further comprising:
transmitting data to one or more entities associated with an enrollment into a capital management product.

24. The method of claim 23 further comprising:
transmitting data relevant to the interests of the one or more entities associated with an enrollment into a capital management product.

25. The method of claim 1 further comprising:
securely transmitting data to one or more external entities associated with an enrollment into a capital management product.

26. The method of claim 1 further comprising:
securely transmitting data to one or more operations units.

27. The method of claim 1 further comprising:
receiving inputs from one or more of a group comprising a user, an operations group, a client, a partner administrator, a bank, a financial advisor, a financial specialist, a product manager, a business manager and an account manager.

28. The method of claim 1 further comprising:
transmitting system messages to one or more of a group comprising a user, an operations group, a client, a partner administrator, a bank, a financial advisor, a financial specialist, a product manager, a business manager and an account manager.

29. The method of claim 1 further comprising:
transmitting data to one or more of a group comprising a user, an operations group, a client, a partner administrator, a bank, a financial advisor, a financial specialist, a product manager, a business manager and an account manager.

30. The method of claim 1 further comprising:
providing a customizable user interface to facilitate operation of one or more functions associated with an enrollment into a capital management product.

31. The method of claim 2 further comprising:
initiating a dispatch of customer introductory material.

32. The method of claim 31 further comprising:
transmitting data to facilitate with the dispatch of customer introductory material.

33. The method of claim 1 further comprising:
reporting enrollment data to at least one user at one or more phases of an enrollment.

34. The method of claim 1 further comprising:
automatically supplying information for at least a portion of said proposal from data in memory.

35. The method of claim 2 further comprising:
automatically supplying information for at least a portion of recommended capital management product package from data in memory.

36. A processor-implemented method for facilitating an enrollment into a capital management product, comprising:
receiving customer data into a system designed for enrollment of a customer into a capital management product;
processing said customer data to determine if at least a previously-defined capital management product package is appropriate using said system;
determining which previously-defined capital management product package of a set of previously-defined capital management products is appropriate when said system determines that a previously-defined capital management product package is appropriate;
determining at least a parameter of a capital management product package based at least in part on said customer data when said system determines that a previously-defined capital management product package is appropriate;
generating a customer proposal concerning at least the previously-defined capital management product package determined appropriate by the system when said system determines that a previously-defined capital management product package is appropriate;
processing said customer data to determine if a custom-designed capital management product package is appropriate using said system;
generating a system message requesting that at least a custom-designed capital management product package be designed for said customer when said system determines that a custom-designed capital management product package is appropriate;
receiving a proposal concerning at least the custom-designed capital management product package into memory on the system when a custom-designed capital management product package is designed;
receiving additional data into said system when said customer accepts a customer proposal concerning a capital management product package;
processing said customer data and said additional data to generate at least a portion of an enrollment application;
generating at least a parameter of a capital management product based on at least a portion of said enrollment application;
storing at least an aspect of said generated capital management product into memory associated with said system; and
transmitting a system message that at least a portion of a capital management product has been generated.

37. The method of claim 36, wherein the capital management product is selected from a group comprising one or more of a lockbox product, zero-balance account, delayed disbursement, remote deposit and electronic data exchange.

38. The method of claim 36, further comprising:
generating a revised customer proposal in response to one or more authorized changes to a capital management product package.

39. A computer program, stored on a computer readable medium and executable by a computer system, the computer program comprising:
a data collection module capable of receiving data from one or more sources and storing said data on a computer storage media;
a profile analysis module capable of processing data stored on a computer storage media and recommending a capital management product;
a proposal module capable of generating a proposal for a recommended capital management product;
a notification module capable of transmitting a system message to one or more entities outside of the system;
where said data collection module receives data comprising one or more factors associated with a capital management product or party to be enrolled in a capital management product;
where said profile analysis module employs computer logic to determine whether to recommend a previously-defined capital management product, a custom-designed capital management product, a combination of previously-defined and custom-designed capital management products, or no capital management product;
where said proposal module generates at least a portion of a proposal for a recommended capital management product if a capital management product is recommended by said profile analysis module; and
where said notification module transmits at least a system message concerning at least a capital management product or enrollment.

40. The computer system of claim 39 further comprising:
an enrollment form module capable of generating at least a portion of an enrollment form, where said enrollment form module generates at least a portion of an enrollment form for at least a recommended capital management product if a capital management product is recommended by said profile analysis module comprising at least a portion derived from said data comprising one or more factors associated with a capital management product or party to be enrolled in a capital management product.

41. The computer system of claim 39 further comprising:
a reporting module capable of generating at least a portion of a report, where said reporting module generates at least a portion of a report, said report summarizing data associated with an enrollment into a capital management product.

42. The computer system of claim 39 further comprising:
where said notification module transmits a system message to at least a user, said system message comprising elements selected from a group comprising one or more of informational elements, actionable elements, communications elements, data forwarding elements and file forwarding elements.

43. The computer system of claim 39 further comprising:
a user access module capable of regulating user access to the system, where said user access defines a user's right to access one or more system components and data;
where said user access module allows one or more users access to the system; and
where said user access module regulates user access depending upon one or more factors selected from a group comprising a relationship between the user and the system, a relationship between the user and the enrollment, a relationship between the user and the capital management product, a relationship between the user and the party to be enrolled in the capital management product, characteristics of the user or previously determined access rights.

44. The computer system of claim 39 further comprising:
where said profile analysis module employs computer logic to determine which previously-defined capital management product to recommend when a previously-defined capital management product is recommended.

45. The computer system of claim 44 further comprising:
a product amendment module capable of facilitating an amendment to at least a portion of a capital management product, where said product amendment module facilitates amendment of at least a portion of a capital management product by a user.

46. The computer system of claim 39 further comprising:
a user interface module capable of providing one or more users with one or more interfaces to the system to facilitate operation of one or more functions of the system, where said user interface module provides a user interface to a user where at least a portion of said user interface is customizable.

47. The computer system of claim 39 further comprising:
a user interface module capable of providing one or more users with one or more interfaces to the system to facilitate operation of one or more functions of the system, where said user interface module provides a user interface to a user where at least a portion of said user interface is tailored to said user's interests with the system.

48. The computer system of claim 39 further comprising:
where said notification module transmits a system message requesting that a capital management product be designed to meet one or more factors associated with a capital management product or party to be enrolled in a capital management product when a custom-designed capital management product is recommended.

49. The computer system of claim 48 further comprising:
where said data collection module receives data comprising at least a portion of a capital management product structure designed to meet one or more factors associated with a capital management product or party to be enrolled in a capital management product.

50. The computer system of claim 49 further comprising:
a product amendment module capable of facilitating an amendment to at least a portion of a capital management product, where said product amendment module facilitates amendment of at least a portion of a capital management product structure by a user.

51. The computer system of claim 39 further comprising:
a product module capable of generating at least a portion of a capital management product structure, where said product module generates at least an element of a recommended capital management product.

52. The computer system of claim 39 further comprising:
where said data collection module receives data comprising at least a portion of a capital management product structure.

53. The computer system of claim 39 further comprising:
where said proposal module facilitates amendment of at least a portion of a proposal by a user.

54. The computer system of claim 39 wherein the capital management product is selected from a group comprising one or more of a lockbox product, zero-balance account, delayed disbursement, remote deposit and electronic data exchange.

55. An apparatus for facilitating an enrollment into a capital management product comprising:
a system bus;
a processor communicatively connected to the system bus;
computer readable storage media communicatively connected to the system bus storing a program which, when executed causes the computer system to perform the following:
inputting data comprising one or more factors associated with a capital management product or party to be enrolled in a capital management product;
processing said data, employing computer logic to determine whether to recommend a previously-defined capital management product, a custom-designed capital management product, a combination of previously-defined and custom-designed capital management products, or no capital management product; and
outputting data concerning a recommended capital management product if a capital management product is recommended.

56. The method of claim 55 wherein the capital management product is selected from a group comprising one or more of a lockbox product, zero-balance account, delayed disbursement, remote deposit and electronic data exchange.

57. The apparatus of claim 55 wherein said system bus is communicatively connected to a communications network over which data may be transmitted.

58. The apparatus of claim 55 wherein said system bus is communicatively connected to a database for collection and organization of data.
